(19) United States
(12) Patent Application Publication
(10) Pub. No.: US 2021/0136783 A1
(43) Pub. Date: May 6, 2021

(54) REVERSED SIDELINK COMMUNICATION INITIATED BY RECEIVING USER EQUIPMENT

(71) Applicant: QUALCOMM INCORPORATED, San Diego, CA (US)

(72) Inventors: Seyed Ali Akbar Fakoorian, San Diego, CA (US); Jing Sun, San Diego, CA (US); Xiaoxia Zhang, San Diego, CA (US)

(21) Appl. No.: 17/083,162

(22) Filed: Oct. 28, 2020

Related U.S. Application Data
(60) Provisional application No. 62/928,274, filed on Oct. 30, 2019.

(51) Int. Cl. H04W 72/12; H04W 72/04; H04W 72/14

(52) U.S. Cl. CPC H04W 72/12; H04W 72/14; H04W 72/0406

(57) ABSTRACT

Wireless communications systems and methods related to reverse sidelink communication initiated by a receiving user equipment (UE) are provided. In one embodiment, a first UE transmits at least one of sidelink channel information or a sidelink scheduling information. The first UE receives, from a second UE, sidelink data based on at least one of the transmitted sidelink channel information or the transmitted sidelink scheduling information. In one embodiment, a first UE receives, from a second UE, at least one of sidelink channel information or a sidelink scheduling information. The first UE transmits, to the second UE, sidelink data based on at least one of the received sidelink channel information or the received sidelink scheduling information.

### CROSS REFERENCE TO RELATED APPLICATIONS

The present application claims priority to and the benefit of U.S. Provisional Patent Application No. 62/928,274, filed Oct. 30, 2019, which is hereby incorporated by reference in its entirety as if fully set forth below and for all applicable purposes.

### TECHNICAL FIELD

This application relates to wireless communication systems, and more particularly to reverse sidelink communication initiated by a receiving user equipment (UE).

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the long term evolution (LTE) technology to a next generation new radio (NR) technology, which may be referred to as 5^{th} Generation (5G). For example, NR is designed to provide a lower latency, a higher bandwidth or a higher throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

In a wireless communication network, a BS may communicate with a UE in an uplink direction and a downlink direction. Sidelink was introduced in LTE to allow a UE to send data to another UE without tunneling through the BS and/or an associated core network. The LTE sidelink technology had been extended to provision for device-to-device (D2D) communications, vehicle-to-everything (V2X) communications, and/or cellular vehicle-to-everything (C-V2X) communications. Similarly, NR may be extended to support sidelink communications for D2D, V2X, and/or C-V2X over a dedicated spectrum, a licensed spectrum, and/or an unlicensed spectrum.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication, including transmitting, by a first user equipment (UE), at least one of sidelink channel information or a sidelink scheduling information; and receiving, by the first UE from a second UE, sidelink data based on at least one of the transmitted sidelink channel information or the transmitted sidelink scheduling information.

In an additional aspect of the disclosure, a method of wireless communication, including receiving, by a first user equipment (UE) from a second UE, at least one of sidelink channel information or a sidelink scheduling information; and transmitting, by the first UE to the second UE, sidelink data based on at least one of the received sidelink channel information or the received sidelink scheduling information.

In an additional aspect of the disclosure, a first user equipment (UE) including a transceiver configured to transmit at least one of sidelink channel information or a sidelink scheduling information; and receive, from a second UE, sidelink data based on at least one of the transmitted sidelink channel information or the transmitted sidelink scheduling information.

In an additional aspect of the disclosure, a first user equipment (UE) including a transceiver configured to receive, from a second UE, at least one of sidelink channel information or a sidelink scheduling information; and transmit, to the second UE, sidelink data based on at least one of the received sidelink channel information or the received sidelink scheduling information.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 illustrates a wireless communication network according to some aspects of the present disclosure.

FIG. 2 illustrates a radio frame structure according to some aspects of the present disclosure.

FIG. 3 illustrates a wireless communication network that provisions for sidelink communications according to some aspects of the present disclosure.

FIG. 4A illustrates a physical sidelink control channel (PSCCH)/physical sidelink shared channel (PSSCH) multiplexing configuration according to some aspects of the present disclosure.

FIG. 4B illustrates a PSCCH/PSSCH multiplexing configuration according to some aspects of the present disclosure.

FIG. 4C illustrates a PSCCH/PSSCH multiplexing configuration according to some aspects of the present disclosure.

FIG. 4D illustrates a PSCCH/PSSCH multiplexing configuration according to some aspects of the present disclosure.

FIG. 5 is a block diagram of a user equipment (UE) according to some aspects of the present disclosure.

FIG. 6 is a block diagram of an exemplary base station (BS) according to some aspects of the present disclosure.

FIG. 7A illustrates a sidelink transmission according to some aspects of the present disclosure.

FIG. 7B is a signaling diagram illustrating a sidelink communication method according to some aspects of the present disclosure.

FIG. 8A illustrates a sidelink transmission according to some aspects of the present disclosure.

FIG. 8B is a signaling diagram illustrating a sidelink communication method according to some aspects of the present disclosure

FIG. 9A illustrates a sidelink transmission according to some aspects of the present disclosure.

FIG. 9B is a signaling diagram illustrating a sidelink communication method according to some aspects of the present disclosure

FIG. 10A illustrates a sidelink transmission according to some aspects of the present disclosure.

FIG. 10B is a signaling diagram illustrating a sidelink communication method according to some aspects of the present disclosure

FIG. 11 is a signaling diagram illustrating a sidelink communication method according to some aspects of the present disclosure

FIG. 12 is a signaling diagram illustrating a sidelink communication method according to some aspects of the present disclosure

FIG. 13 is a signaling diagram illustrating a sidelink communication method according to some aspects of the present disclosure

FIG. 14 illustrates a sidelink scheduling timeline according to some aspects of the present disclosure.

FIG. 15 is a flow diagram of a sidelink communication method that implements hybrid automatic repeat request (HARQ) according to some aspects of the present disclosure.

FIG. 16 is a flow diagram of a sidelink communication method that implements HARQ according to some aspects of the present disclosure.

FIG. 17 is a signaling diagram illustrating a sidelink data pending indication scheme according to some aspects of the present disclosure.

FIG. 18 is a signaling diagram illustrating a sidelink data pending indication scheme according to some aspects of the present disclosure.

FIG. 19 is a signaling diagram illustrating a sidelink data pending indication scheme according to some aspects of the present disclosure.

FIG. 20 is a signaling diagram illustrating a sidelink data pending indication scheme according to some aspects of the present disclosure.

FIG. 21 illustrates a channel occupancy time (COT) sharing scheme for sidelink communication according to some aspects of the present disclosure.

FIG. 22 is a flow diagram of a COT sharing method for sidelink communication according to some aspects of the present disclosure.

FIG. 23 is a flow diagram of a communication method according to some aspects of the present disclosure.

FIG. 24 is a flow diagram of a communication method according to some aspects of the present disclosure.

FIG. 25 is a flow diagram of a communication method according to some aspects of the present disclosure.

FIG. 26 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various aspects, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, Global System for Mobile Communications (GSM) networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the UMTS mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

Sidelink communications refers to the communications among user equipment devices (UEs) without tunneling through a base station (BS) and/or a core network. Sidelink communication can be communicated over a physical sidelink control channel (PSCCH) and a physical sidelink shared channel (PSSCH). The PSCCH and PSSCH are analogous to a physical downlink control channel (PDCCH) and a physical downlink shared channel (PDSCH) in downlink (DL) communication between a BS and a UE. For instance, the PSCCH may carry sidelink control information (SCI) and the PSSCH may carry sidelink data. Each PSCCH is associated with a corresponding PSSCH, where SCI in a PSCCH may carry scheduling information for sidelink data transmission in the associated PSSCH. In NR vehicle-to-everything (V2X), a transmitting UE may initiate SCI and sidelink data transmission to a receiving UE. The transmitting UE may select resources for the sidelink transmission based on channel sensing and channel measurements. The sensing and channel measurements performed by the transmitting UE may present channel conditions and/or interference at the transmitting UE, but may not necessarily represent channel conditions and/or interference experienced by the receiving UE where data is being received and decoded. Accordingly, a resource selected by the transmitting UE may not be a most suitable resource for the receiving UE.

The present application describes mechanisms for reverse sidelink communication where a receiving UE may initiate a sidelink transmission instead of a transmitting UE as in conventional sidelink communication. For instance, a receiving UE may initiate a sidelink transmission by transmitting scheduling information to a transmitting UE for the sidelink transmission. The scheduling information may indicate a sidelink resource (e.g., a time-frequency resource) and/or transmission parameters (e.g., modulation coding scheme (MCS) and/or demodulation reference signal (DMRS) pattern) for the sidelink transmission. Upon receiving the scheduling information, the transmitting UE may transmit sidelink data to the receiving UE according to the received scheduling information. The transmission of the sidelink data from the transmitting UE to the receiving UE may be referred to as a forward sidelink communication. The transmission of the scheduling information from the receiving UE to the transmitting UE may be referred to as a reverse sidelink communication. The sidelink scheduling information may be transmitted by the receiving UE in the form of SCI via a PSCCH. The sidelink data may be transmitted by the transmitting UE via a PSSCH. In this context, a receiving UE is understood to be a UE that receives user data (e.g., over PSSCH) from another UE in a sidelink communication, while a transmitting UE is understood to be a UE that transmits user data (e.g., over PSSCH) to another UE in a sidelink communication. In some instances, the receiving UE may transmit control information to the transmitting UE. Over time, a single UE may be both a receiving UE and a transmitting UE. For example, in an initial sidelink communication a UE may be a receiving UE and in a later sidelink communication the same UE may be a transmitting UE, or vice versa.

In some aspects, the receiving UE may determine the sidelink scheduling information. For instance, the receiving UE may select a sidelink resource from a resource pool and/or determine transmission parameters for the sidelink transmission based on channel sensing and/or channel measurements over the sidelink channel. In some aspects, the receiving UE may transmit the sidelink scheduling information in two stages. For example, the receiving UE may transmit a stage SCI indicating general resource allocation or reservation information that may facilitate sensing by other sidelink UEs. Subsequently, the receiving UE may transmit a second stage SCI indicating more specific transmission parameters (e.g., MCS, DMRS pattern) that are to be used for the sidelink data transmission. Alternatively, the receiving UE may determine the resource allocation and transmit the first stage SCI while the transmitting UE may determine the transmission parameters and transmit the second stage SCI.

In some aspects, the first UE may receive a sidelink grant from a BS and transmit the sidelink scheduling information based on the received sidelink grant. In other words, the BS may select sidelink resources and/or determine transmission parameters for the sidelink data transmission on behalf of the receiving UE.

In some aspects, the receiving UE may receive a sidelink data pending indication (e.g., a buffer status report (BSR) and/or a scheduling request (SR)) from the transmitting UE and may determine the sidelink scheduling information in response to the sidelink data pending indication. In some aspects, the receiving UE may transmit control information (e.g., channel quality indicator (CQI), channel sensing information, and/or any other information related to the sidelink channel) to the transmitting UE and/or the BS to assist sidelink scheduling. The receiving UE may provide channel information over a wider bandwidth than the PSSCH bandwidth where sidelink data is communicated.

In some aspects, when operating over a shared radio frequency band, sidelink transmissions can be gated by listen-before-talk (LBT) failures. The receiving UE may contend for a channel occupancy time (COT) and share the COT with the transmitting UE or the BS upon failing to detect a transmission from the transmitting UE or the BS for a duration of time. In some instances, the receiving UE may contend for the COT based on a timer. The receiving UE may initialize and/or reinitialize the timer upon receiving a transmission from the transmitting UE or the BS and may contend for the COT when the timer expires.

Aspects of the present disclosure can provide several benefits. For example, the initiation of a sidelink transmission by the receiving UE allows the receiving UE to select the best resource (e.g., with the least amount of interference) for receiving sidelink data, and thus sidelink communication performance may improve. Additionally, the initiation of COT sharing by the receiving UE may allow the transmitting UE to transmit pending sidelink data to the receiving UE that may otherwise be gated by LBT failure at the transmitting UE.

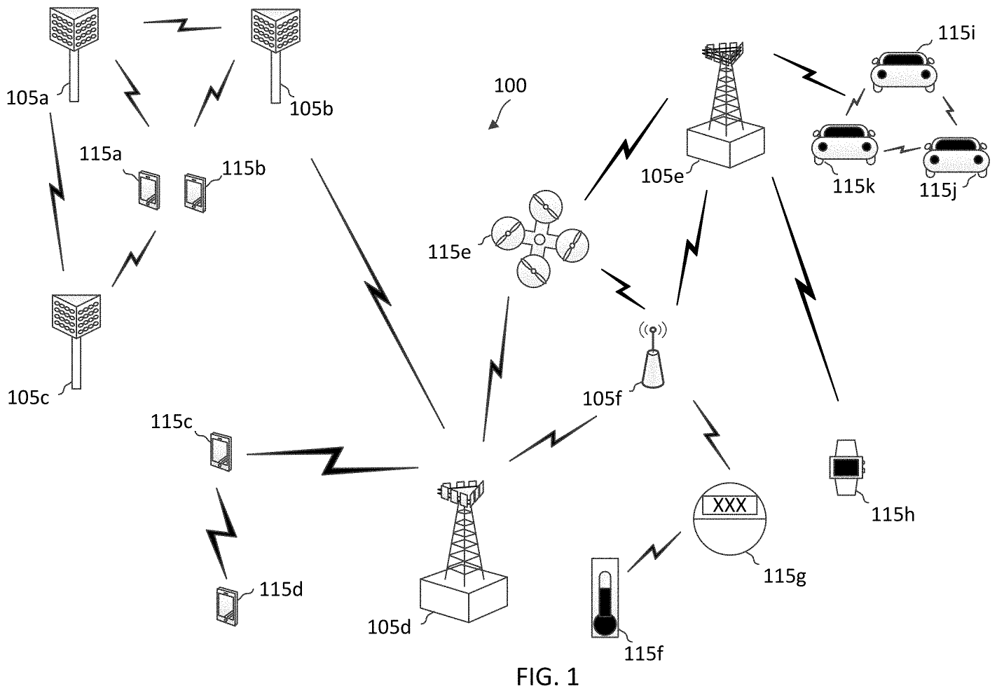

FIG. 1 illustrates a wireless communication network 100 according to some aspects of the present disclosure. The network 100 may be a 5G network. The network 100 includes a number of base stations (BSs) 105 (individually labeled as 105a, 105b, 105c, 105d, 105e, and 105f) and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of a gNB or an access node controller (ANC)) may interface with the core network through backhaul links (e.g., NG-C, NG-U, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a drone. Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-step-size configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as V2V, V2X, C-V2X communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some aspects, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes or slots, for example, about 10. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel. Control information may include resource assignments and protocol controls. Data may include protocol data and/or operational data. In some aspects, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some aspects, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining system information (RMSI), and other system information (OSI)) to facilitate initial network access. In some instances, the BSs 105 may broadcast the PSS, the SSS, and/or the MIB in the form of synchronization signal block (SSBs) over a physical broadcast channel (PBCH) and may broadcast the RMSI and/or the OSI over a physical downlink shared channel (PDSCH).

In some aspects, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical UL control channel (PUCCH), physical UL shared channel (PUSCH), power control, and SRS.

After obtaining the MIB, the RMSI and/or the OSI, the UE 115 can perform a random access procedure to establish a connection with the BS 105. In some examples, the random access procedure may be a four-step random access procedure. For example, the UE 115 may transmit a random access preamble and the BS 105 may respond with a random access response. The random access response (RAR) may include a detected random access preamble identifier (ID) corresponding to the random access preamble, timing advance (TA) information, a UL grant, a temporary cell-radio network temporary identifier (C-RNTI), and/or a backoff indicator. Upon receiving the random access response, the UE 115 may transmit a connection request to the BS 105 and the BS 105 may respond with a connection response. The connection response may indicate a contention resolution. In some examples, the random access preamble, the RAR, the connection request, and the connection response can be referred to as message 1 (MSG1), message 2 (MSG2), message 3 (MSG3), and message 4 (MSG4), respectively. In some examples, the random access procedure may be a two-step random access procedure, where the UE 115 may transmit a random access preamble and a connection request in a single transmission and the BS 105 may respond by transmitting a random access response and a connection response in a single transmission.

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The scheduling grants may be transmitted in the form of DL control information (DCI). The BS 105 may transmit a DL communication signal (e.g., carrying data) to the UE 115 via a PDSCH according to a DL scheduling grant. The UE 115 may transmit a UL communication signal to the BS 105 via a PUSCH and/or PUCCH according to a UL scheduling grant.

In some aspects, the BS 105 may communicate with a UE 115 using HARQ techniques to improve communication reliability, for example, to provide a URLLC service. The BS 105 may schedule a UE 115 for a PDSCH communication by transmitting a DL grant in a PDCCH. The BS 105 may transmit a DL data packet to the UE 115 according to the schedule in the PDSCH. The DL data packet may be transmitted in the form of a transport block (TB). If the UE 115 receives the DL data packet successfully, the UE 115 may transmit a HARQ ACK to the BS 105. Conversely, if the UE 115 fails to receive the DL transmission successfully, the UE 115 may transmit a HARQ NACK to the BS 105. Upon receiving a HARQ NACK from the UE 115, the BS 105 may retransmit the DL data packet to the UE 115. The retransmission may include the same coded version of DL data as the initial transmission. Alternatively, the retransmission may include a different coded version of the DL data than the initial transmission. The UE 115 may apply soft-combining to combine the encoded data received from the initial transmission and the retransmission for decoding. The BS 105 and the UE 115 may also apply HARQ for UL communications using substantially similar mechanisms as the DL HARQ.

In some aspects, the network 100 may operate over a system BW or a component carrier (CC) BW. The network 100 may partition the system BW into multiple BWPs (e.g., portions). A BS 105 may dynamically assign a UE 115 to operate over a certain BWP (e.g., a certain portion of the system BW). The assigned BWP may be referred to as the active BWP. The UE 115 may monitor the active BWP for signaling information from the BS 105. The BS 105 may schedule the UE 115 for UL or DL communications in the active BWP. In some aspects, a BS 105 may assign a pair of BWPs within the CC to a UE 115 for UL and DL communications. For example, the BWP pair may include one BWP for UL communications and one BWP for DL communications.

In some aspects, the network 100 may operate over a shared channel, which may include shared frequency bands and/or unlicensed frequency bands. For example, the network 100 may be an NR-unlicensed (NR-U) network operating over an unlicensed frequency band. In such an aspect, the BSs 105 and the UEs 115 may be operated by multiple network operating entities. To avoid collisions, the BSs 105 and the UEs 115 may employ a listen-before-talk (LBT) procedure to monitor for transmission opportunities (TXOPs) in the shared channel. A TXOP may also be referred to as channel occupancy time (COT). For example, a transmitting node (e.g., a BS 105 or a UE 115) may perform an LBT prior to transmitting in the channel. When the LBT passes, the transmitting node may proceed with the transmission. When the LBT fails, the transmitting node may refrain from transmitting in the channel.

An LBT can be based on energy detection or signal detection. For an energy detection-based LBT, the LBT results in a pass when signal energy measured from the channel is below a threshold. Conversely, the LBT results in a failure when signal energy measured from the channel exceeds the threshold. For a signal detection-based LBT, the LBT results in a pass when a channel reservation signal (e.g., a predetermined preamble signal) is not detected in the channel. Additionally, an LBT may be in a variety of modes. An LBT mode may be, for example, a category 4 (CAT4) LBT or a category 2 (CAT2) LBT. A CAT2 LBT refers to an LBT without a random backoff period. A CAT4 LBT refers to an LBT with a random backoff and a variable contention window (CW).

In some aspects, the network 100 may provision for sidelink communications to allow a UE 115 to communicate with another UE 115 without tunneling through a BS 105 and/or the core network. A pair of transmitting-receiving UEs 115 may communicate with each other over a sidelink in a forward link direction and a reverse link direction. The network 100 may support reverse sidelink communication where a receiving UE 115 may initiate a sidelink transmission, for example, by transmitting a sidelink grant schedule to a transmitting UE 115. Mechanisms for reserve sidelink communication are described in greater detail herein. In this regard, a receiving UE is understood to be a UE that receives data (e.g., over PSSCH) from another UE in a sidelink communication, while a transmitting UE is understood to be a UE that transmits data (e.g., over PSSCH) to another UE in a sidelink communication. Over time, a single UE may be both a receiving UE and a transmitting UE. For example, in an initial sidelink communication a UE may be a receiving UE and in a later sidelink communication the same UE may be a transmitting UE, or vice versa.

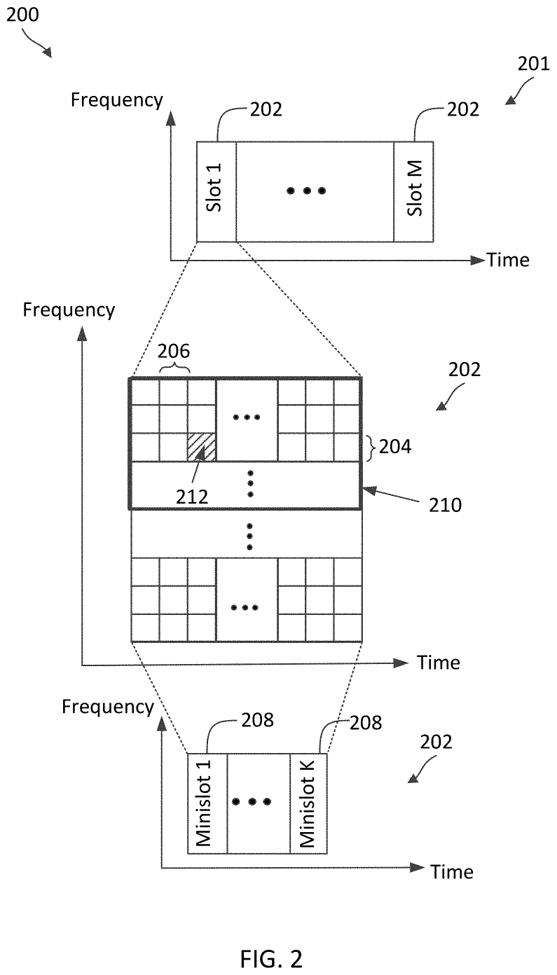

FIG. 2 is a timing diagram illustrating a radio frame structure 200 according to some aspects of the present disclosure. The radio frame structure 200 may be employed by BSs such as the BSs 105 and UEs such as the UEs 115 in a network such as the network 100 for communications. In particular, the BS may communicate with the UE using time-frequency resources configured as shown in the radio frame structure 200. In FIG. 2, the x-axes represent time in some arbitrary units and the y-axes represent frequency in some arbitrary units. The transmission frame structure 200 includes a radio frame 201. The duration of the radio frame 201 may vary depending on the aspects. In an example, the radio frame 201 may have a duration of about ten milliseconds. The radio frame 201 includes M number of slots 202, where M may be any suitable positive integer. In an example, M may be about 10.

Each slot 202 includes a number of subcarriers 204 in frequency and a number of symbols 206 in time. The number of subcarriers 204 and/or the number of symbols 206 in a slot 202 may vary depending on the aspects, for example, based on the channel bandwidth, the subcarrier spacing (SCS), and/or the CP mode. One subcarrier 204 in frequency and one symbol 206 in time forms one resource element (RE) 212 for transmission. A resource block (RB) 210 is formed from a number of consecutive subcarriers 204 in frequency and a number of consecutive symbols 206 in time.

In an example, a BS (e.g., BS 105 in FIG. 1) may schedule a UE (e.g., UE 115 in FIG. 1) for UL and/or DL communications at a time-granularity of slots 202 or mini-slots 208. Each slot 202 may be time-partitioned into K number of mini-slots 208. Each mini-slot 208 may include one or more symbols 206. The mini-slots 208 in a slot 202 may have variable lengths. For example, when a slot 202 includes N number of symbols 206, a mini-slot 208 may have a length between one symbol 206 and (N−1) symbols 206. In some aspects, a mini-slot 208 may have a length of about two symbols 206, about four symbols 206, or about seven symbols 206. In some examples, the BS may schedule UE at a frequency-granularity of a resource block (RB) 210 (e.g., including about 12 subcarriers 204).

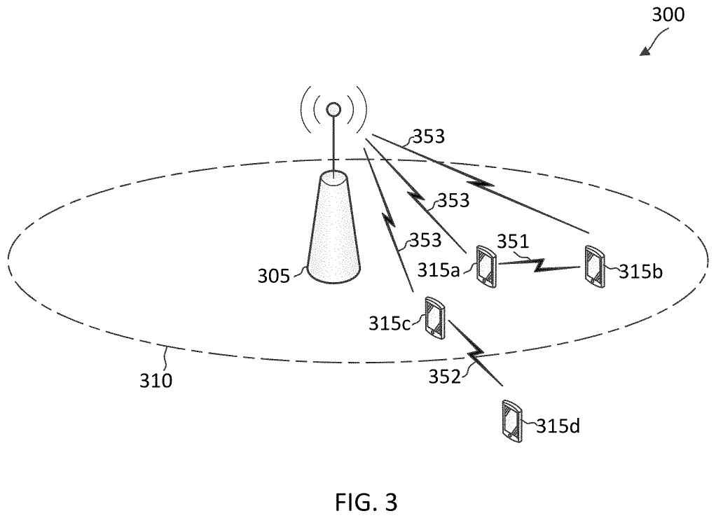

FIG. 3 illustrates an example of a wireless communication network 300 that provisions for sidelink communications according to aspects of the present disclosure. The network 300 may be similar to the network 100. The network 300 may use a radio frame structure similar to radio frame structure 200 for communication. FIG. 3 illustrates one BSs 305 and four UEs 315 for purposes of simplicity of discussion, though it will be recognized that aspects of the present disclosure may scale to any suitable number of UEs 315 and/or BSs 305 (e.g., the about 3, 3, 6, 7, 8, or more). The BS 305 and the UEs 315 may be similar to the BSs 105 and the UEs 115, respectively. The BSs 305 and the UEs 315 may communicate over the same spectrum.

In the network 300, some of the UEs 315 may communicate with each other in peer-to-peer communications. For example, the UE 315a may communicate with the UE 315b over a sidelink 351, and the UE 315c may communicate with the UE 315d over another sidelink 352. The sidelinks 351 and 352 are unicast bidirectional links. Some of the UEs 315 may also communicate with the BS 305 in a UL direction and/or a DL direction via communication links 353. For instance, the UE 315a, 315b, and 315c are within a coverage area 310 of the BS 305, and thus may be in communication with the BS 305. The UE 315d is outside the coverage area 310, and thus may not be in direct communication with the BS 305. In some instances, the UE 315c may operate as a relay for the UE 315d to reach the BS 305. In some aspects, some of the UEs 315 are associated with vehicles (e.g., similar to the UEs 115i-k) and the communications over the sidelinks 351 and/or 352 may be C-V2X communications. C-V2X communications may refer to communications between vehicles and any other wireless communication devices in a cellular network.

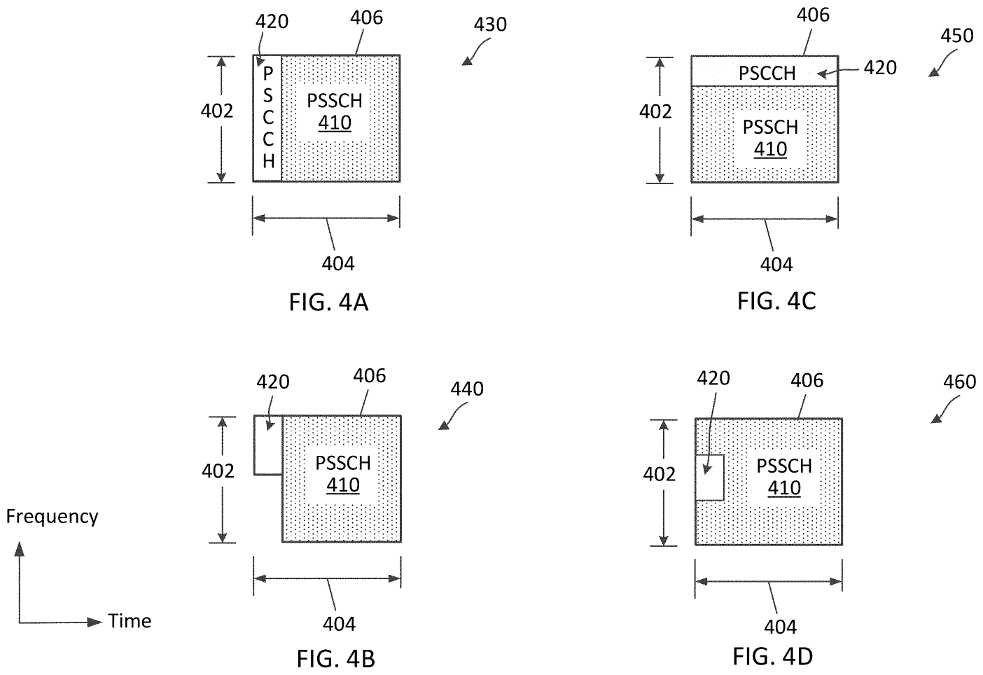

FIGS. 4A-4D illustrates various exemplary PSCCH/PSSCH multiplexing configurations for sidelink communication. In FIGS. 4A-4D, the PSCCH/PSSCH multiplexing configurations 430, 440, 450, and 460 may be employed by BSs such as the BSs 105 and 305 and/or UEs such as the UEs 115 and/or 315 in a network such as the networks 100 and/or 300. In particular, the UEs may communicate with each other over sidelinks (e.g., the sidelinks 351 and 352) using resources configured as shown in the configuration 430, 440, 450, or 460. Additionally, the x-axes represent time in some arbitrary units, and the y-axes represent frequency in some arbitrary units.

FIG. 4A illustrates a PSCCH/PSSCH multiplexing configuration 430 according to some aspects of the present disclosure. In the configuration 430, a PSSCH 410 and a PSCCH 420 are time-multiplexed in a sidelink resource 406. The sidelink resource may span a frequency band 402 and a time duration 404. The sidelink resource 406 may have a transmission structure similar to the structure shown in FIG. 2 discussed above. For instance, the sidelink resource 406 may include a number of subcarriers 214 in frequency and a number of symbols 206, a number of mini-slots 208, or a number of slots 202 in time. In some instances, the frequency band 402 may be within a licensed band. In some other instances, the frequency band 402 may be within a shared radio frequency band in a shared spectrum or an unlicensed spectrum. In some instances, the frequency band 402 may be within a 5 gigahertz (GHz) band or a 6 GHz band and may be shared among multiple network operating entities and/or multiple radio access technologies (RATs).

FIG. 4B illustrates a PSCCH/PSSCH multiplexing configuration 440 according to some aspects of the present disclosure. The configuration 440 is substantially similar to the configuration 430, where the PSSCH 410 is time-multiplexed with the PSCCH 420. However, the PSCCH 420 may occupy a narrower bandwidth than the PSSCH 410.

FIG. 4C illustrates a PSCCH/PSSCH multiplexing configuration 450 according to some aspects of the present disclosure. In the configuration 450, the PSSCH 410 and the PSCCH 420 are frequency-multiplexed in the sidelink resource 406.

FIG. 4D illustrates a PSCCH/PSSCH multiplexing configuration 460 according to some aspects of the present disclosure. In the configuration 460, the PSSCH 410 and the PSCCH 420 are multiplexed in time and frequency in the sidelink resource 406. In some aspects, the configuration 460 may be suitable for sidelink transmissions that use cyclic-prefix-OFDM (CP-OFDM) waveforms. In general, PSCCH and PSSCH may be multiplexed using any suitable time and/or frequency multiplexing configurations.

A network (e.g., the networks 100 and/or 300) may utilize any of the PSCCH/PSSCH multiplexing configurations 430, 440, 450, or 460 for sidelink communication. Prior to a sidelink communication, the PSCCH/PSSCH multiplexing configuration, the starting symbol (e.g., the symbols 206), the number of symbols, and/or the number of subcarriers (e.g., the subcarriers 214) for a PSSCH 410 and/or the number of symbols and the number of subcarriers for a PSCCH 420 are known to all UEs (e.g., in the UEs 115 and 315) in the network, for example, based on a pre-configuration by the BS. In each resource 406, the PSCCH 420 is associated with the PSSCH 410. For instance, the PSCCH 420 may carry SCI indicating scheduling information for sidelink data carried in the corresponding PSSCH 410.

During a sidelink communication, a transmitting UE (e.g., the UEs 115 and/or 315) may initiate the sidelink transmission by transmitting SCI in a PSCCH 420 (of a resource 406) indicating scheduling information for sidelink data in the corresponding PSSCH 410. The scheduling information may indicate time and/or frequency resources in the PSSCH 410 where sidelink data is to be transmitted. The scheduling information may indicate transmission parameters, such as a MCS level and/or a DMRS pattern, to be used for transmitting the sidelink data. A receiving UE may monitor for SCI in the PSCCH 420 and receive sidelink data based on detected SCI. The receiving UE may determine whether the receiving UE is the intended destination based on a destination ID included in the sidelink data.

There are two modes of sidelink resource allocations. In mode-1, a BS (e.g., the BSs 105 and/or 305) may determine sidelink resources (e.g., for PSCCH 420 and PSSCH 410) for a transmitting UE. In other words, the BS determines a sidelink resource on behalf of the transmitting UE. The BS may transmit a dynamic grant (e.g., via PDCCH DCI) to the transmitting UE. The dynamic sidelink grant may indicate the sidelink resource. The transmitting UE may transmit SCI in the PSCCH 420 to indicate a sidelink data resources (in the PSSCH 410) to a receiving UE.

In mode-2, a transmitting UE may determine sidelink resources instead of a BS. In this regard, sidelink UEs may be preconfigured with a resource pool for sidelink operations. A resource pool is a set of resources, which may be in the form of slots (e.g., the slots 202) and/or RBs (e.g., the RBs 210). For instance, the resource pool may include a number of sidelink resources similar to the resources 406 arranged as shown in the configuration 430, 440, 450, or 460 of FIGS. 4A, 4B, 4C, or 4D, respectively. The time and frequency resource locations of the PSCCH 420 are known based on a selected PSCCH/PSSCH multiplexing configuration (e.g., the configurations 430, 440, 450, and 460). A transmitting UE may perform channel sensing in the PSCCH 420 regions of the resource pool, for example, by monitoring and decoding SCIs transmitted by other sidelink UEs. Based on the SCI monitoring and decoding, the transmitting UE may determine whether a sidelink resource 406 is being used by another sidelink UE and how long and/or in which subband a sidelink UE may occupy a sidelink resource 406. The transmitting UE may also perform sidelink channel measurements to determine interference in the sidelink resources 406 within the resource pool. The transmitting UE may select a resource 406 from the resource pool for a sidelink communication based on the monitoring and/or channel measurements. For example, the selected resource 406 may be a resource with a minimal amount of interference among resources in the resource pool as seen by the transmitting UE. The sidelink communication may be an initial transmission or a retransmission, for example, when using HARQ as discussed above.

In some aspects, an SCI payload may include an indication of a priority for a corresponding sidelink transmission. The priority can be different from a data priority assigned by a higher layer for the corresponding sidelink transmission. The priority indication may facilitate contention or usage of the sidelink resource and/or interference management. For instance, when a transmitting UE detected SCI from another UE indicating a high-priority transmission scheduled for a corresponding PSSCH 410, the transmitting UE may be more conservative in using the PSSCH 410 for transmission. For example, the transmitting UE may use a lower energy detection threshold to determine whether the transmitting UE may transmit in the PSSCH 410. Conversely, when a transmitting UE detected SCI from another UE indicating a low-priority transmission scheduled for a corresponding PSSCH 410, the transmitting UE may be less conservative in transmitting in the PSSCH 410. For example, the transmitting UE may use a higher energy detection threshold to determine whether the transmitting UE may use the PSSCH 410 for transmission.

The current PSCCH and PSSCH in NR sidelink communication is similar to a DL grant and DL data in DL transmissions, where a transmitter sends both control (e.g., scheduling) information and data to a receiver. In traditional UL grant-based NR scheduling, a BS (e.g., the BSs 105 and/or 305) may grant a UL transmission to a UE. While a transmitting UE may perform sensing for sidelink communications and/or a BS may grant a transmitting UE with a sidelink source, there are scenarios where a receiving UE (e.g., the UEs 115 and/or 315) may be a better source at determining whether a resource or subband may be better for receiving data. For example, the sensing and/or channel measurements performed by a transmitting UE may provide interference information at the transmitting UE, whereas sensing and/or channel measurements performed by a receiving UE may provide interference information at the receiving UE where data is being received and decoded. As such, the receiving UE may be better in selecting and scheduling resources for sidelink communication than the transmitting UE.

Additionally, in NR V2X, a transmitting UE may transmit CSI-RS within a bandwidth of the PSSCH transmission. Thus, while a receiving UE may report CQI based on a CSI-RS, the CQI is limited to the PSSCH bandwidth. For example, if the PSSCH incudes 5 RBs, the CSI-RS transmitted by the transmitting UE is limited to the 5 RBs, and the CQI reported by the receiving UE is limited to the 5 RBs. As such, the transmitting UE may not have channel information outside of the 5 RBs. On the other hand, a receiving UE may receive sidelink communication in other subbands or RBs from other sidelink UEs. As such, the receiving UE may have channel information on a wider bandwidth, and thus may be better in performing scheduling or resource selection than the transmitting UE. Further, when the receiving UE is receiving sidelink communication from multiple transmitting UEs, the receiving UE may be better at resource scheduling and/or interference management as the receiving UE is aware of all the communications at the receiving UE.

Accordingly, the present disclosure provides techniques for reverse sidelink communication where a receiving UE may initiate or schedule sidelink transmissions.

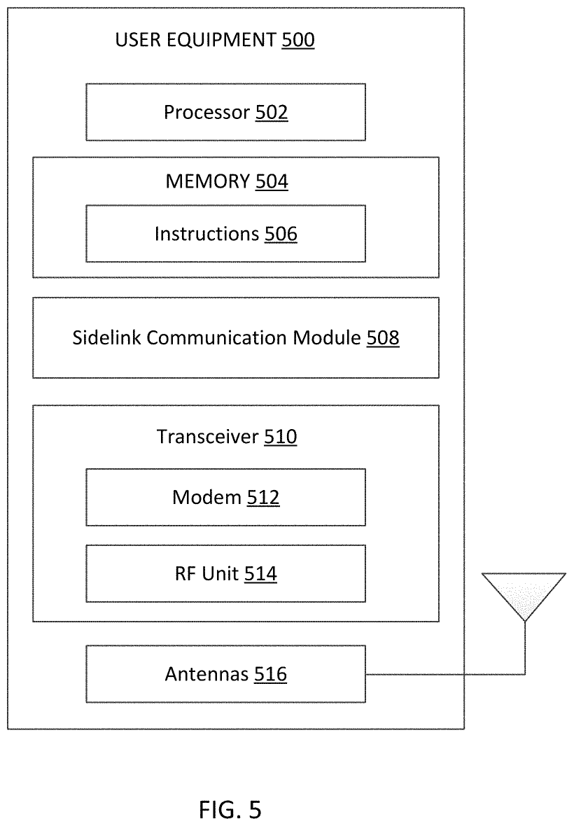

FIG. 5 is a block diagram of an exemplary UE 500 according to some aspects of the present disclosure. The UE 500 may be a UE 115 discussed above in FIG. 1. As shown, the UE 500 may include a processor 502, a memory 504, a sidelink communication module 508, a transceiver 510 including a modem subsystem 512 and a radio frequency (RF) unit 514, and one or more antennas 516. These elements may be in direct or indirect communication with each other, for example via one or more buses.

The processor 502 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 504 includes a non-transitory computer-readable medium. The memory 504 may store, or have recorded thereon, instructions 506. The instructions 506 may include instructions that, when executed by the processor 502, cause the processor 502 to perform the operations described herein with reference to the UEs 115 in connection with aspects of the present disclosure, for example, aspects of FIGS. 3-4 and 7-24, and 26. Instructions 506 may also be referred to as program code. The program code may be for causing a wireless communication device to perform these operations, for example by causing one or more processors (such as processor 502) to control or command the wireless communication device to do so. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The sidelink communication module 508 may be implemented via hardware, software, or combinations thereof. For example, the sidelink communication module 508 may be implemented as a processor, circuit, and/or instructions 506 stored in the memory 504 and executed by the processor 502. In some instances, the sidelink communication module 508 can be integrated within the modem subsystem 512. For example, the sidelink communication module 508 can be implemented by a combination of software components (e.g., executed by a DSP or a general processor) and hardware components (e.g., logic gates and circuitry) within the modem subsystem 512.

The sidelink communication module 508 may be used for various aspects of the present disclosure, for example, aspects of FIGS. 3-4 and 7-24, and 26. In some aspects, the UE 500 may operate as a sidelink receiving UE and the sidelink communication module 508 is configured to transmit sidelink scheduling information to a transmitting UE (e.g., the UEs 115 and/or 315) for sidelink data transmission and receive sidelink data from the transmitting UE based on the transmitted sidelink scheduling information. In some instances, the sidelink communication module 508 is configured to transmit the sidelink scheduling information to the transmitting UE in the form of SCI via a PSCCH and receive the sidelink data from the transmitting UE via a PSSCH. In some instances, the sidelink communication module 508 is configured to transmit the sidelink scheduling information using a 2-stage SCI, for example, the first stage SCI indicating general resource allocation or reservation to facilitate sensing and the second stage SCI indicating more specific transmission parameters (e.g., MCS, DMRS pattern) for the sidelink data. In some instances, the sidelink communication module 508 is configured to transmit the first stage SCI and receive the second stage SCI from the transmitting UE. In some instances, the sidelink communication module 508 is configured to receive a sidelink grant from a BS (e.g., the BSs 105 and/or 305) and transmit the sidelink scheduling information based on the sidelink grant. In some instances, the sidelink communication module 508 is configured to receive a data pending indication from the transmitting UE and determine the sidelink scheduling information in response to the data pending indication. In some instances, the sidelink communication module 508 is configured to transmit, to the transmitting UE and/or the BS, control information (e.g., including a CQI, channel sensing information, and/or any other information) that may facilitate a transmission from the transmitting UE to the UE 500 over a sidelink.

In some aspects, the sidelink communication module 508 is configured to determine a sidelink COT in a shared radio frequency band in response to a failure to detect a sidelink communication and transmit a sidelink COT indicator including information for sharing the COT. In some instances, the sidelink communication module 508 is configured to determine the sidelink COT based on receiving a sidelink data pending indication from the second UE. In some instances, the sidelink communication module 508 is configured to determine the sidelink COT based on a timer. For instance, the processor 502 may be integrated with a time or counter module. Alternatively, the UE 500 may include a separate timer or counter module. The sidelink communication module 508 is configured to start and/or restart the timer based on receiving a transmission from the transmitting UE or a BS and determine the COT when the timer expires. The sidelink communication module 508 is configured to determine an expiration period for the timer based on whether the UE 500 is expecting a transmission from the transmitting UE or from the BS and/or whether the last transmission received from the BS or the transmitting UE is a control signal or data.

In some aspects, the UE 500 may operate as a sidelink transmitting UE and the sidelink communication module 508 is configured to receive sidelink scheduling information from a receiving UE for a sidelink data transmission and transmit sidelink data to the receiving UE based on the received sidelink scheduling information. In some instances, the sidelink communication module 508 is configured to receive the sidelink scheduling information from the receiving UE in the form of SCI via a PSCCH and transmit the sidelink data from the receiving UE via a PSSCH. In some instances, the sidelink communication module 508 is configured to receive the sidelink scheduling information in the form of 2-stage SCI, for example, the first stage SCI indicating general resource allocation or reservation to facilitate sensing and the second stage SCI indicating more specific transmission parameters (e.g., MCS, DMRS pattern) for the sidelink data. In some instances, the sidelink communication module 508 is configured to receive the first stage SCI, determine transmission parameters for the sidelink data, and transmit the second stage SCI to the receiving UE. In some instances, the sidelink communication module 508 is configured to transmit a data pending indication to the receiving UE and receive the sidelink scheduling information in response to the data pending indication. In some instances, the sidelink communication module 508 is configured to receive, from the receiving UE, control information (e.g., including a CQI, channel sensing information, and/or any other information) that may facilitate a transmission from the UE 500 to the receiving UE over a sidelink. Mechanisms for reverse sidelink communication are described in greater detail herein.

As shown, the transceiver 510 may include the modem subsystem 512 and the RF unit 514. The transceiver 510 can be configured to communicate bi-directionally with other devices, such as the BSs 105. The modem subsystem 512 may be configured to modulate and/or encode the data from the memory 504 and/or the sidelink communication module 508 according to a modulation and coding scheme (MCS), e.g., a low-density parity check (LDPC) coding scheme, a turbo coding scheme, a convolutional coding scheme, a polar coding scheme, a digital beamforming scheme, etc. The RF unit 514 may be configured to process (e.g., perform analog to digital conversion or digital to analog conversion, etc.) modulated/encoded data (e.g., sidelink scheduling information, sidelink data, sidelink CQI, sidelink sensing information, HARQ ACK/NACK, BSR, SR) from the modem subsystem 512 (on outbound transmissions) or of transmissions originating from another source such as a UE 115 or a BS 105. The RF unit 514 may be further configured to perform analog beamforming in conjunction with the digital beamforming. Although shown as integrated together in transceiver 510, the modem subsystem 512 and the RF unit 514 may be separate devices that are coupled together at the UE 115 to enable the UE 115 to communicate with other devices.

The RF unit 514 may provide the modulated and/or processed data, e.g. data packets (or, more generally, data messages that may contain one or more data packets and other information), to the antennas 516 for transmission to one or more other devices. The antennas 516 may further receive data messages transmitted from other devices. The antennas 516 may provide the received data messages for processing and/or demodulation at the transceiver 510. The transceiver 510 may provide the demodulated and decoded data (e.g., sidelink grants, sidelink scheduling information, sidelink data, CQI, HARQ ACK/NACK, BSR, SR) to the configured transmission module 507 for processing. The antennas 516 may include multiple antennas of similar or different designs in order to sustain multiple transmission links. The RF unit 514 may configure the antennas 516.

In an example, the transceiver 510 is configured to transmit sidelink scheduling information to a transmitting UE for sidelink data transmission and receive sidelink data from the transmitting UE based on the transmitted sidelink scheduling information, for example, by coordinating with the sidelink communication module 508.

In an example, the transceiver 510 is configured to receive sidelink scheduling information from a receiving UE for a sidelink data transmission and transmit sidelink data to the receiving UE based on the received sidelink scheduling information, for example, by coordinating with the sidelink communication module 508.

In an aspect, the UE 500 can include multiple transceivers 510 implementing different RATs (e.g., NR and LTE). In an aspect, the UE 500 can include a single transceiver 510 implementing multiple RATs (e.g., NR and LTE). In an aspect, the transceiver 510 can include various components, where different combinations of components can implement different RATs.

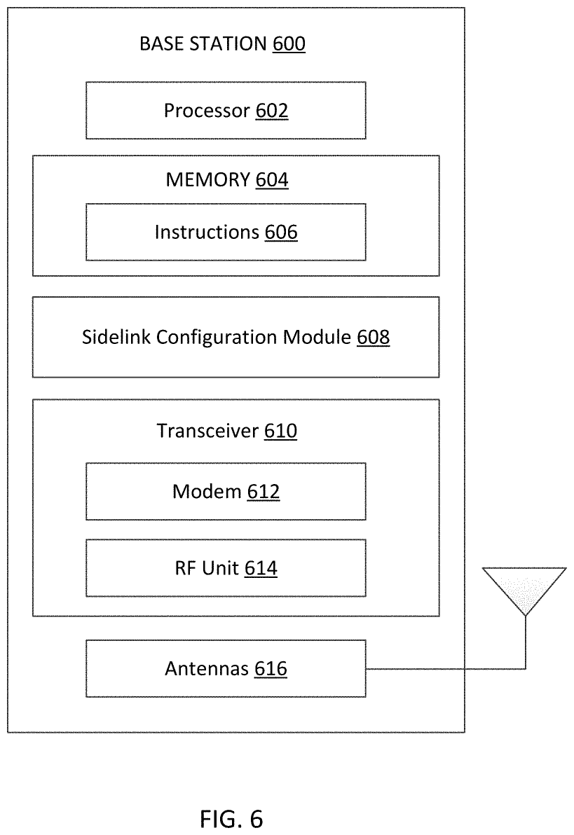

FIG. 6 is a block diagram of an exemplary BS 600 according to some aspects of the present disclosure. The BS 600 may be a BS 105 in the network 100 as discussed above in FIG. 1. A shown, the BS 600 may include a processor 602, a memory 604, a sidelink configuration module 608, a transceiver 610 including a modem subsystem 612 and a RF unit 614, and one or more antennas 616. These elements may be in direct or indirect communication with each other, for example via one or more buses.

The processor 602 may have various features as a specific-type processor. For example, these may include a CPU, a DSP, an ASIC, a controller, a FPGA device, another hardware device, a firmware device, or any combination thereof configured to perform the operations described herein. The processor 602 may also be implemented as a combination of computing devices, e.g., a combination of a DSP and a microprocessor, a plurality of microprocessors, one or more microprocessors in conjunction with a DSP core, or any other such configuration.

The memory 604 may include a cache memory (e.g., a cache memory of the processor 602), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 604 may include a non-transitory computer-readable medium. The memory 604 may store instructions 606. The instructions 606 may include instructions that, when executed by the processor 602, cause the processor 602 to perform operations described herein, for example, aspects of FIGS. 3, 7, 11, 17-18, and 25. Instructions 606 may also be referred to as code, which may be interpreted broadly to include any type of computer-readable statement(s) as discussed above with respect to FIG. 5.

The sidelink configuration module 608 may be implemented via hardware, software, or combinations thereof. For example, the sidelink configuration module 608 may be implemented as a processor, circuit, and/or instructions 606 stored in the memory 604 and executed by the processor 602. In some instances, the sidelink configuration module 608 can be integrated within the modem subsystem 612. For example, the sidelink configuration module 608 can be implemented by a combination of software components (e.g., executed by a DSP or a general processor) and hardware components (e.g., logic gates and circuitry) within the modem subsystem 612.

The sidelink configuration module 608 may be used for various aspects of the present disclosure, for example, aspects of FIGS. 3, 7, 11, 17-18, and 25. The sidelink configuration module 608 is configured to determine a sidelink grant for a transmitting UE (e.g., the UEs 115, 315, and/or 500) to transmit sidelink data to a receiving UE (e.g., the UEs 115, 315, and/or 500) and transmit, to the receiving UE, the sidelink grant for initiating a transmission of the sidelink data.

In some instances, the sidelink configuration module 608 is configured to receive a sidelink data pending indication from the transmitting UE or the receiving UE and may determine the sidelink grant in response to the sidelink data pending indication. In some instances, the sidelink configuration module 608 is configured to receive, from the receiving UE, control information (e.g., CQIs, channel sensing information, and/or any other information) that may facilitate a transmission from the transmitting UE to the receiving UE and determine the sidelink grant based on the control information. In some instances, the sidelink configuration module 608 is configured to receive an ACK/NACK for the sidelink data from the receiving UE. In some instances, the sidelink configuration module 608 is configured to determine the sidelink grant considering a transmission delay between the BS and the receiving UE and a transmission delay between the transmitting UE and the receiving UE. Mechanisms for facilitating reverse sidelink communications are described in greater detail herein.

As shown, the transceiver 610 may include the modem subsystem 612 and the RF unit 614. The transceiver 610 can be configured to communicate bi-directionally with other devices, such as the UEs 115 and/or 500 and/or another core network element. The modem subsystem 612 may be configured to modulate and/or encode data according to a MCS, e.g., a LDPC coding scheme, a turbo coding scheme, a convolutional coding scheme, a polar coding scheme, a digital beamforming scheme, etc. The RF unit 614 may be configured to process (e.g., perform analog to digital conversion or digital to analog conversion, etc.) modulated/encoded data (e.g., sidelink resource pool configuration, sidelink grants) from the modem subsystem 612 (on outbound transmissions) or of transmissions originating from another source such as a UE 115 and/or UE 500. The RF unit 614 may be further configured to perform analog beamforming in conjunction with the digital beamforming. Although shown as integrated together in transceiver 610, the modem subsystem 612 and/or the RF unit 614 may be separate devices that are coupled together at the BS 105 to enable the BS 105 to communicate with other devices.

The RF unit 614 may provide the modulated and/or processed data, e.g. data packets (or, more generally, data messages that may contain one or more data packets and other information), to the antennas 616 for transmission to one or more other devices. This may include, for example, transmission of information to complete attachment to a network and communication with a camped UE 115 or 500 according to some aspects of the present disclosure. The antennas 616 may further receive data messages transmitted from other devices and provide the received data messages for processing and/or demodulation at the transceiver 610. The transceiver 610 may provide the demodulated and decoded data (e.g., sidelink CQI, sidelink channel sensing information, HARQ ACK/NACK, BSR) to the sidelink configuration module 608 for processing. The antennas 616 may include multiple antennas of similar or different designs in order to sustain multiple transmission links.

In an example, the transceiver 610 is configured to, transmit sidelink grant to a sidelink receiving UE, receive sidelink channel information and/or any other control information for sidelink communication, sidelink BSRs, and/or sidelink ACK/NACK from the sidelink receiving UE, for example, by coordinating with the sidelink configuration module 608.

In an aspect, the BS 600 can include multiple transceivers 610 implementing different RATs (e.g., NR and LTE). In an aspect, the BS 600 can include a single transceiver 610 implementing multiple RATs (e.g., NR and LTE). In an aspect, the transceiver 610 can include various components, where different combinations of components can implement different RATs.

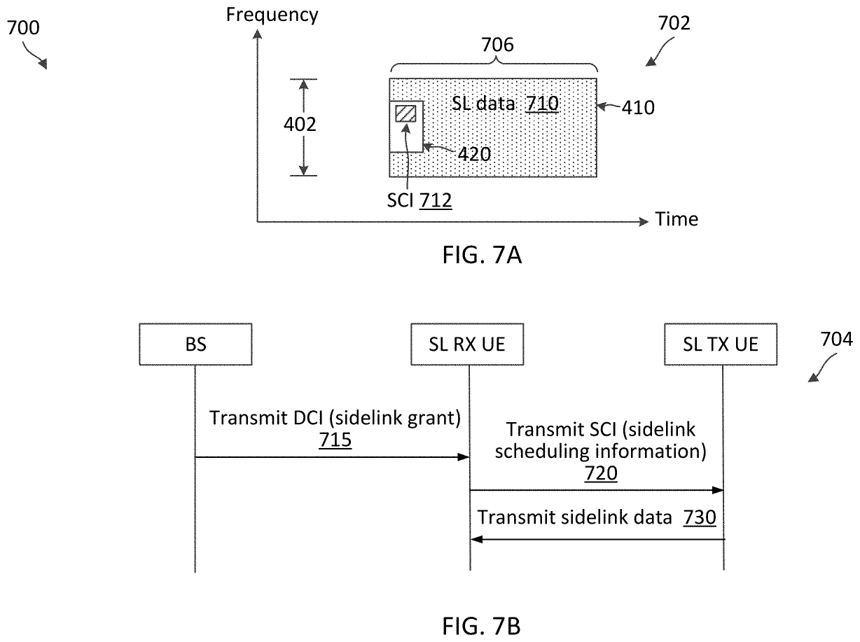

FIG. 7A will be discussed in relation to FIG. 7B to illustrate a sidelink communication scheme 700. The scheme 700 may be employed by BSs and UEs such as the UEs 115, 315, and/or 500 in a network such as the networks 100 and 300 for sidelink communications. In particular, a sidelink receiving (SL RX) UE may initiate sidelink transmission with a sidelink transmitting (SL TX UE) based on a sidelink grant provided by a BS as shown in the scheme 700. In some aspects, the SL RX UE and the SL TX UE may correspond to the UEs 315a and 315b, respectively, and the BS may correspond to the BS 305. In some aspects, the SL RX UE and the SL TX UE may correspond to the UEs 315c and 315d, respectively, and the BS may correspond to the BS 305.

FIG. 7A illustrates a sidelink transmission 702 (between the SL RX UE and the SL TX UE) according to some aspects of the present disclosure. In FIG. 7A, the x-axis represents time in some arbitrary units, and the y-axis represents frequency in some arbitrary units. For purposes of simplicity of discussion, the sidelink transmission 702 is illustrated using the PSCCH/PSSCH multiplexing configuration 460 of FIG. 4D and uses the same reference numerals as in FIG. 4. However, the scheme 700 may utilize any other suitable PSCCH/PSSCH multiplexing configuration (e.g., the configurations 430, 440, or 450). FIG. 7B is a signaling diagram illustrating a sidelink communication method 704 according to some aspects of the present disclosure. The method 704 may be implemented between the BS, the SL RX UE, and the SL TX. As illustrated, the method 704 includes a number of enumerated steps, but aspects of the method 704 may include additional steps before, after, and in between the enumerated steps. In some aspects, one or more of the enumerated steps may be omitted or performed in a different order.

At step 715, the BS transmits DCI to the SL RX UE, for example, via a PDCCH. The DCI indicates a dynamic sidelink grant to the SL RX UE. The DCI may indicate a sidelink resource and transmission parameters for sidelink transmission. The sidelink resource may correspond to a sidelink resource 706 of FIG. 7A, where the sidelink resource 706 is within a certain time period 404 and a certain frequency subband 402 and may include a PSCCH 420 and a PSSCH 410. In some instances, the BS may allocate the sidelink resource based on channel quality reports, BSRs, SRs, and/or HARQ ACK/NACKs received from the SL RX UE and/or the SL TX UE. The transmission parameters may include a MCS level and/or a DMRS pattern for the sidelink transmission in the PSSCH 410. Some examples of MCS level may include quadrature-phase shift keying (QPSK), 16-quadrature amplitude modulation (16 QAM), or the like. The DMRS pattern may indicate one or more symbol locations (e.g., the symbols 206) and/or frequency locations within the PSSCH 410 where a DMRS sequence may be transmitted. The BS may determine the transmission parameters based on channel quality reports received from the SL RX UE, the SL TX UE, and/or other UEs in the network. In some instances, the BS may utilize one or more components, such as the processor 602, the sidelink configuration module 608, the transceiver 610, the modem 612, and the one or more antennas 616, to allocate the sidelink resource and transmit the DCI.

At step 720, upon receiving the DCI from the BS, the SL RX UE transmits SCI indicating sidelink scheduling information to the SL TX UE based on the DCI. The SL RX UE may transmit the SCI as shown in FIG. 7A, where the SCI (shown as SCI 712) is transmitted in the PSCCH 420. The scheduling information may indicate sidelink resources within the PSSCH 410 of the resource 706 allocated by the BS. The scheduled sidelink resource may correspond to a portion of the PSSCH 410 or the entire portion of the PSSCH 410. The scheduling information may include the transmission parameters received from the DCI. In some instances, the SL RX UE may utilize one or more components, such as the processor 502, the sidelink communication module 508, the transceiver 510, the modem 512, and the one or more antennas 516, to receive the DCI from the BS and transmit the SCI 712 to the SL TX UE.

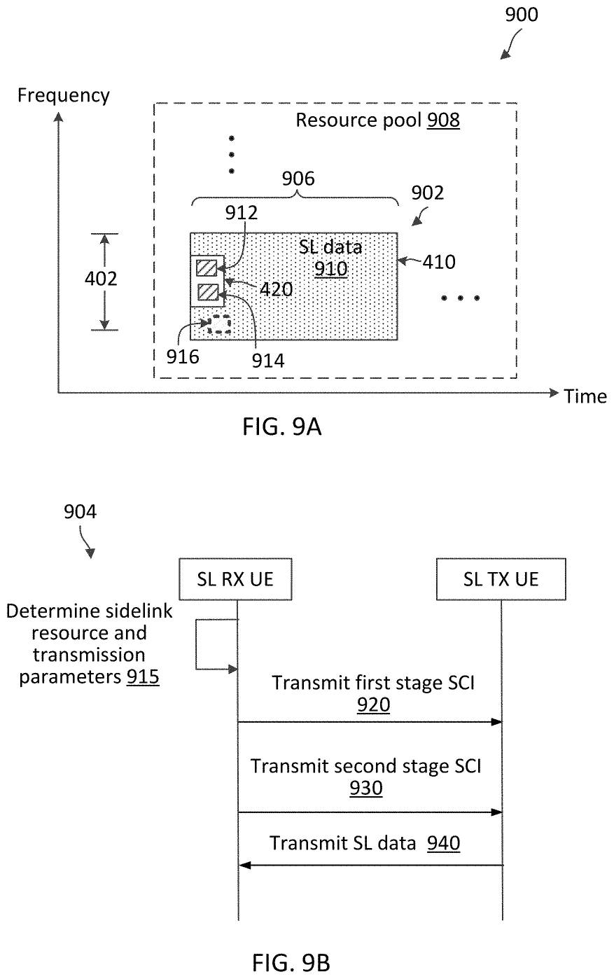

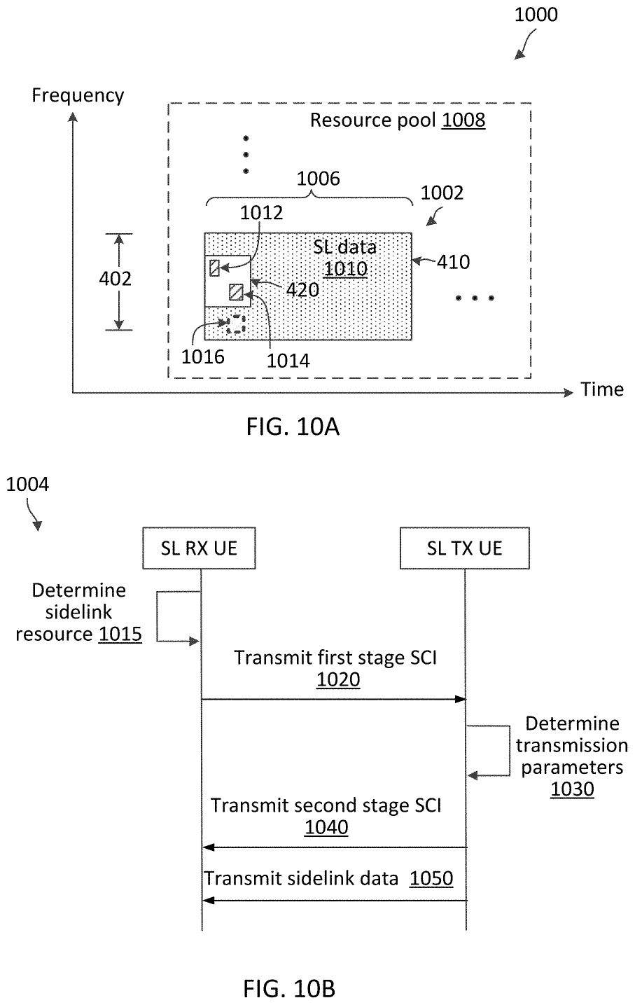

At step 730, upon receiving the SCI 712 from the SL RX UE, the SL TX UE transmits sidelink data according to the SCI 712. For instance, the SL TX UE may transmit the sidelink data in the resources indicated by the SCI 712 and using the transmission parameters indicated by the SCI 712. The SL TX UE may transmit the sidelink data as shown in FIG. 7A, where the sidelink data (shown as sidelink data 710) is transmitted in the PSSCH 410 of the resource 706. In some instances, the SL TX UE may utilize one or more components, such as the processor 502, the sidelink communication module 508, the transceiver 510, the modem 512, and the one or more antennas 516, to receive the SCI 712 from the SL RX UE and transmit the sidelink data 710 to the SL RX UE. As explained above, the SCI 712 transmitted by the SL RX UE may indicate sidelink resources and the transmission parameters for the SL TX UE to transmit the sidelink data 710. In general, the SCI 712 may indicate similar information as would be indicated via two-stage SCI as discussed below in FIGS. 9A and 10A. For instance, SCI 712 may indicate similar information as the first stage SCI 912 and second stage SCI 914 (or 916) of FIG. 9A and/or the first stage SCI 1012 and the second stage SCI 1014 of FIG. 10A.

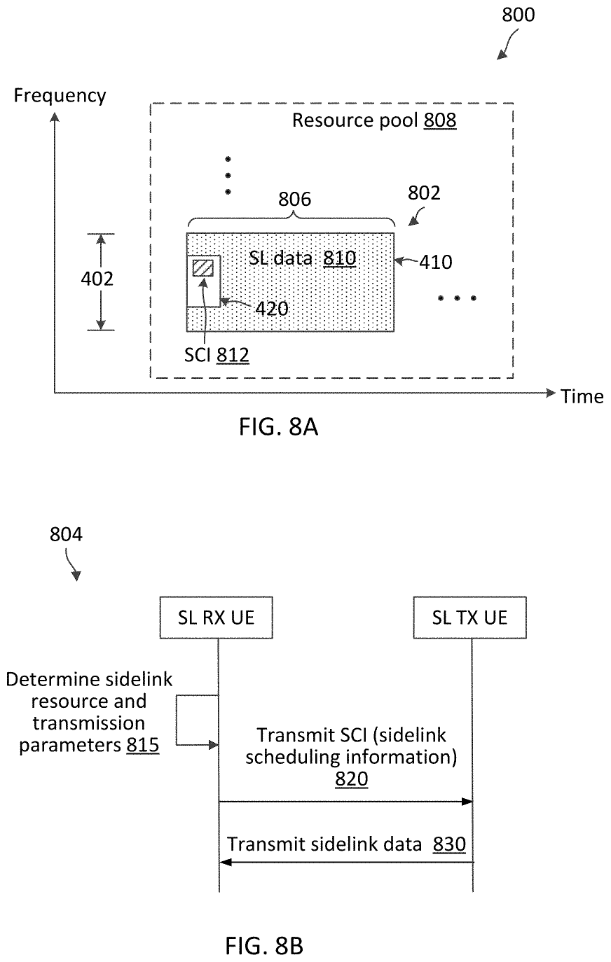

FIG. 8A will be discussed in relation to FIG. 8B to illustrate a sidelink communication scheme 800. The scheme 800 may be employed by UEs such as the UEs 115, 315, and/or 500 in a network such as the networks 100 and 300 for sidelink communications. In particular, a SL RX UE may initiate sidelink transmission with a SL TX UE based on a sidelink schedule determined by the SL RX UE as shown in the scheme 800. In some aspects, the SL RX UE and the SL TX UE may correspond to the UEs 315a and 315b, respectively. In some aspects, the SL RX UE and the SL TX UE may correspond to the UEs 315c and 315d, respectively. The scheme 800 is substantially similar to the scheme 700, but sidelink scheduling information is determined by the SL RX UE instead of the BS.

FIG. 8A illustrates a sidelink transmission 802 (between the SL RX UE and the SL TX UE) according to some aspects of the present disclosure. In FIG. 8A, the x-axis represents time in some arbitrary units, and the y-axis represents frequency in some arbitrary units. For purposes of simplicity of discussion, the sidelink transmission 802 is illustrated using the PSCCH/PSSCH multiplexing configuration 460 of FIG. 4D and uses the same reference numerals as in FIG. 4. However, the scheme 800 may utilize any other suitable PSCCH/PSSCH multiplexing configuration (e.g., the configurations 430, 440, or 450). FIG. 8B is a signaling diagram illustrating a sidelink communication method 804 according to some aspects of the present disclosure. The method 804 may be implemented between the SL RX UE and the SL TX UE. As illustrated, the method 804 includes a number of enumerated steps, but aspects of the method 804 may include additional steps before, after, and in between the enumerated steps. In some aspects, one or more of the enumerated steps may be omitted or performed in a different order.

At step 815, the SL RX UE determines a sidelink resource and transmission parameters for the SL TX UE to transmit sidelink data to the SL RX UE. In this regard, the SL RX UE may select a resource 806 (shown in FIG. 8A) similar to the resource 406 and 706 from a resource pool 808. The resource pool 808 may be preconfigured, for example, by a BS (e.g., the BSs 105, 305, and/or 600). The resource pool 808 may include a number of resources similar to the resource 806. While FIG. 8A illustrates the resource pool 808 with in a continuous time-frequency region, the resource pool 808 may include resources distributed in time and/or frequency. The SL RX UE may select the resource 806 by performing channel sensing and/or measurements on the resource pool. The SL RX UE may perform the sensing based on monitoring and/or decoding of SCIs transmitted by other UEs in the PSCCH region of the resource pool as discussed above. For instance, the SL RX UE may receive a signal from the frequency band 402, perform blind decoding in the PSCCH region to determine whether an SCI is detected from the signal. The SL RX UE may perform channel measurements to determine interference at certain resources that the SL RX UE may experience. The SL RX UE may select the resource 806 with the minimal interference for the SL TX UE to transmit sidelink data to the SL RX UE. The SL RX UE may determine the transmission parameters, for example, including MCS and DMRS pattern, based on the sensing and channel measurements. In some instances, the SL RX UE may utilize one or more components, such as the processor 502, the sidelink communication module 508, the transceiver 510, the modem 512, and the one or more antennas 516, to perform channel sensing, channel measurements, and/or determine the sidelink resource 806 and transmission parameters. The SL RX UE may store configuration information related to the resource pool in a memory, such as the memory 504.

At step 820, the SL RX UE transmits SCI 812 in the PSCCH 420 of the resource 806. The SCI 812 may be substantially similar to the SCI 712. For instance, the SCI 812 may indicate scheduling information, such as sidelink resources in the PSSCH 410 of the resource 806 and transmission parameters for sidelink data transmission. The SL RX UE may perform step 820 using similar mechanisms as discussed in step 720.

At step 830, upon receiving the SCI 812, the SL TX UE transmits the sidelink data 810 to the SL RX UE in the PSSCH 410 of the resource 806 based on the SCI 812. The SL TX UE may perform step 830 using similar mechanisms as discussed in step 730. In some aspects, the SL RX UE may schedule multiple SL TX UEs using the scheme 700. For instance, the SL RX UE may schedule resources similar to the resource 806 for different SL TX UEs using time-division multiplexing (TDM), frequency-division multiplexing (FDM), and/or spatial-division multiplexing (SDM). As explained above, the SCI 812 transmitted by the SL RX UE may indicate scheduling information, such as sidelink resources and the transmission parameters, for the SL TX UE to transmit the sidelink data 810. In general, the SCI 812 may indicate similar information as would be indicated via two-stage SCI as discussed below in FIGS. 9A and 10A. For instance, SCI 812 may indicate similar information as the first stage SCI 912 and second stage SCI 914 (or 916) of FIG. 9A and/or the first stage SCI 1012 and the second stage SCI 1014 of FIG. 10A.

While FIG. 8A illustrates a PSSCH 410 and a corresponding PSCCH 420 located within the same resource pool 808, the scheme 800 may be applied to separate PSCCH resource pool and PSSCH pool. For instance, each PSCCH in a PSCCH resource pool may be associated with a corresponding PSSCH in a PSSCH pool and similar channel sensing and resource selection mechanisms as discussed in the scheme 800 may be applied.

FIGS. 9A-9B and 10A-10B illustrate various mechanisms for two-stage SCI transmission. FIG. 9A will be discussed in relation to FIG. 9B to illustrate a sidelink communication scheme 900. The scheme 900 may be employed by UEs such as the UEs 115, 315, and/or 500 in a network such as the networks 100 and 300 for sidelink communications. In particular, a SL RX UE may initiate sidelink transmission with a SL TX UE based on a sidelink schedule determined by the SL RX UE as shown in the scheme 900. In some aspects, the SL RX UE and the SL TX UE may correspond to the UEs 315a and 315b, respectively. In some aspects, the SL RX UE and the SL TX UE may correspond to the UEs 315c and 315d, respectively. The scheme 900 is substantially similar to the scheme 800, but SCI is transmitted in two stages instead of a single stage. In other words, the information or content of the SCI 812 of FIG. 8 can be partitioned into two stages or two portions.

FIG. 9A illustrates a sidelink transmission 902 (between the SL RX UE and the SL TX UE) according to some aspects of the present disclosure. In FIG. 9A, the x-axis represents time in some arbitrary units, and the y-axis represents frequency in some arbitrary units. For purposes of simplicity of discussion, the sidelink transmission 902 is illustrated using the PSCCH/PSSCH multiplexing configuration 460 of FIG. 4D and uses the same reference numerals as in FIG. 4. However, the scheme 900 may utilize any other suitable PSCCH/PSSCH multiplexing configuration (e.g., the configurations 430, 440, or 450). FIG. 9B is a signaling diagram illustrating a sidelink communication method 904 according to some aspects of the present disclosure. The method 904 may be implemented between the SL RX UE and the SL TX UE. As illustrated, the method 904 includes a number of enumerated steps, but aspects of the method 904 may include additional steps before, after, and in between the enumerated steps. In some aspects, one or more of the enumerated steps may be omitted or performed in a different order.

At step 915, the SL RX UE determines a sidelink resource 906 (e.g., the resource 706 and/or 806) from a resource pool 908 (e.g., the resource pool 808) and transmission parameters for the SL TX UE to transmit sidelink data to the SL RX UE. The SL RX UE may perform step 915 using similar mechanisms as discussed above in step 815.

At step 920, the SL RX UE transmits a first stage SCI to the SL TX UE. The SL RX UE may transmit the first stage SCI as shown in FIG. 9A, where the first stage SCI (shown as SCI 912) is transmitted in the PSCCH 420 of the resource 906. The first stage SCI 912 may indicate general resource information that may facilitate channel sensing by other UEs. For instance, the first stage SCI 912 may indicate a sidelink resource allocation or reservation within the PSSCH 410. The resource allocation may indicate a duration of the allocation or reservation. The first stage SCI 912 may further indicate a desired transmitter identifier (ID), for example, identifying the SL TX UE as the target transmitter for the allocation. The first stage SCI 912 may further indicate a location of the second stage SCI and/or the aggregation level for decoding a second stage SCI. The aggregation level may be similar to the control channel element (CCE) aggregation used in a PDCCH. In some instances, the SL RX UE may utilize one or more components, such as the processor 502, the sidelink communication module 508, the transceiver 510, the modem 512, and the one or more antennas 516, to transmit the first stage SCI 912 to the SL TX UE.

At step 930, the SL RX UE transmits a second stage SCI to the SL TX UE. The SL RX UE may transmit the second stage SCI as shown in FIG. 9A, where the second stage SCI (shown as SCI 914) is transmitted in the PSCCH 420 of the resource 906. The second stage SCI 914 may provide more detailed configuration information about the sidelink transmission, for example, intended for the destined SL TX UE. For instance, the second stage SCI 914 may indicate the determined the transmission parameters, such as MCS level and/or DMRS pattern for the transmission in the PSSCH 410 of the resource 906. The second stage SCI 914 may further indicate the time and/or frequency resource to be used for the sidelink transmission in the PSSCH 410, data priority, and/or a parameter K1. The time and/or frequency resource may be at a finer granularity than the resource allocation in the first stage SCI 912. For instance, the second stage SCI 1014 may indicate the symbol and/or subcarrier locations where sidelink data is to be transmitted instead of a duration and/or a subband as in the first stage SCI 912. The parameter K1 may refer to the duration between the reception of a sidelink data and the transmission of a HARQ ACK/NACK as discussed in greater detail herein. In some instances, the SL RX UE may utilize one or more components, such as the processor 502, the sidelink communication module 508, the transceiver 510, the modem 512, and the one or more antennas 516, to transmit the second stage SCI 914 to the SL TX UE.

At step 940, upon receiving the SCI 912 and the SCI 914, the SL TX UE transmits the sidelink data 910 to the SL RX UE in the PSSCH 410 of the resource 906 based on the SCI 912 and 914. The SL TX UE may perform step 940 using similar mechanisms as discussed above in step 830.

In some aspects, at step 930, the SL RX UE may transmit the second stage SCI in the PSSCH 410 as shown by the dashed box 916 instead of in the PSCCH 420. In some instances, the second SCI 916 in the PSSCH 410 can be encoded using polar coding similar to PDCCH encoding and may be decoded using DMRS carried in the PSSCH 410. Additionally, although FIG. 9A illustrates the first stage SCI 912 being transmitted in a time period overlapping with the second stage SCI 914 or 916, it should be understood that in other examples the second stage SCI 914 or 916 may be transmitted after first stage SCI 912.

FIG. 10A will be discussed in relation to FIG. 10B to illustrate a sidelink communication scheme 1000. The scheme 1000 may be employed by UEs such as the UEs 115, 315, and/or 500 in a network such as the networks 100 and 300 for sidelink communications. In particular, a sidelink receiving (SL RX) UE may initiate sidelink transmission with a sidelink transmitting (SL TX UE) based on sidelink scheduling information partially determined by the SL RX UE and partially determined by the SL TX UE as shown in the scheme 1000. In some aspects, the SL RX UE and the SL TX UE may correspond to the UEs 315a and 315b, respectively. In some aspects, the SL RX UE and the SL TX UE may correspond to the UEs 315c and 315d, respectively. The scheme 1000 is substantially similar to the scheme 900, but sidelink scheduling information is partially determined by the SL TX UE and the second stage SCI is transmitted by the SL TX UE instead of the SL RX UE.

FIG. 10A illustrates a sidelink transmission 1002 (between the SL RX UE and the SL TX UE) according to some aspects of the present disclosure. In FIG. 10A, the x-axis represents time in some arbitrary units, and the y-axis represents frequency in some arbitrary units. For purposes of simplicity of discussion, the sidelink transmission 1002 is illustrated using the PSCCH/PSSCH multiplexing configuration 460 of FIG. 4D and uses the same reference numerals as in FIG. 4. However, the scheme 1000 may utilize any other suitable PSCCH/PSSCH multiplexing configuration (e.g., the configurations 430, 440, or 450). FIG. 10B is a signaling diagram illustrating a sidelink communication method 1004 according to some aspects of the present disclosure. The method 1004 may be implemented between the SL RX UE and the SL TX UE. As illustrated, the method 1004 includes a number of enumerated steps, but aspects of the method 1004 may include additional steps before, after, and in between the enumerated steps. In some aspects, one or more of the enumerated steps may be omitted or performed in a different order.

At step 1015, the SL RX UE determines a sidelink resource 1006 (e.g., the resource 706, 806, and/or 906) from a resource pool 1008 (e.g., the resource pool 808 and/or 908) for the SL TX UE to transmit sidelink data to the SL RX UE. The SL RX UE may determine the sidelink resource 1006 using substantially similar mechanisms as discussed above in step 815.

At step 1020, the SL RX UE transmits a first stage SCI 1012 to the SL TX UE in the PSCCH 420 of the resource 1006. The first stage SCI 1012 may be similar to the SCI 912. For instance, the first stage SCI 1012 may indicate a sidelink resource allocation or reservation (e.g., including a duration and/or a subband) within the PSSCH 410 and/or a target transmitter ID. The first stage SCI 1012 may further indicate a resource where the SL TX UE may transmit a second stage SCI and/or an aggregation level for the second stage SCI. For instance, when the SL RX UE detected higher interference at the SL RX UE, the SL RX UE may instruct the SL TX UE to use a higher aggregation level (e.g., about 8). Conversely, when the SL RX UE detected low interference at the SL RX UE, the SL RX UE may instruct the SL TX UE to use a lower aggregation level (e.g., about 2).

At step 1030, the SL TX UE determines transmission parameters for sidelink data transmission. The transmission parameters may include a MCS level and/or a DMRS pattern. The SL TX UE may determine the MCS levels and/or the DMRS pattern based on channel measurements performed by the SL TX UE or channel quality reported by the SL RX UE. In some instances, the SL TX UE may utilize one or more components, such as the processor 502, the sidelink communication module 508, the transceiver 510, the modem 512, and the one or more antennas 516, to determine the transmission parameters.

At step 1040, the SL TX UE transmits a second stage SCI 1014 to the SL RX UE in the PSCCH 420 of the resource 1006. Similar to the second stage SCI 914, second stage SCI 1014 provides more detailed scheduling information. For instance, the second stage SCI 1014 may indicate the transmission parameters. The second stage SCI 1014 may further indicate a data priority for the sidelink data transmission in the PSSCH 410. The data priority may indicate a high priority so that other UEs may be more conservative in using the same resource for sidelink data transmission. Conversely, the data priority may indicate a low priority to allow for more opportunistic use of the resource by other UEs. The second stage SCI 1014 may further indicate the time and/or frequency resource to be used for the sidelink data transmission and/or a K1 parameter as discussed above. In some instances, the SL TX UE may utilize one or more components, such as the processor 502, the sidelink communication module 508, the transceiver 510, the modem 512, and the one or more antennas 516, to transmit the second stage SCI 1014, for example, at a resource location indicated by the first stage SCI 1012 and using an aggregation level indicated by the first stage SCI 1012.

At step 1050, the SL TX UE transmits sidelink data 1010 to the SL RX UE in the PSSCH 410 of the resource 1006 based on the SCI 1014. The SL TX UE may perform step 1050 using similar mechanisms as discussed above in step 940.

In some aspects, at step 1040, the SL TX UE may transmit the second stage SCI in the PSSCH 410 as shown by the dashed box 1016 instead of in the PSCCH 420. In some instances, the second SCI 1016 in the PSSCH 410 can be encoded using polar coding similar to PDCCH encoding and may be decoded using DMRS carried in the PSSCH 410.

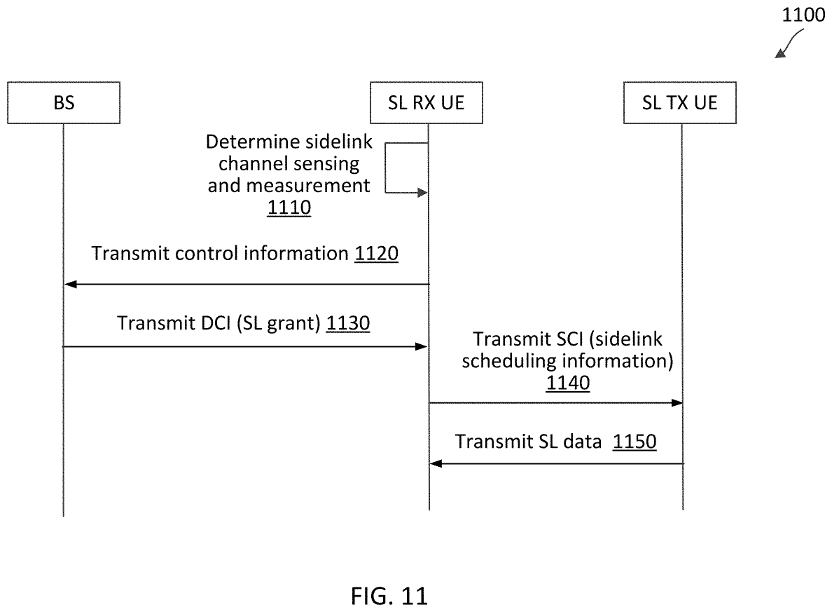

FIGS. 11-13 illustrate various mechanisms for a SL RX UE (e.g., the UEs 115, 315, and/or 500) to provide channel sensing information and/or channel measurement information to a BS (e.g., the BSs 105, 305, and/or 600) and/or a SL TX UE. As discussed above, in NR V2X, CQI is limited to the PSSCH (e.g., the PSSCH 410) bandwidth. However, the SL RX UE is aware of channel information over a wider bandwidth than the PSSCH bandwidth. Thus, the SL RX UE can report CQI over a wider bandwidth or more subbands to facilitate sidelink scheduling. Additionally, when operating in an unlicensed band, there may be hidden node issue. For instance, a sidelink resource pool may be used for mode-1 allocation (by the BS) and mode-2 allocation (by sidelink UEs). The BS may not be aware of which subbands are being used by other sidelink UEs, whereas SL RX UE may have a better estimate of the interference experienced by the SL RX UE itself.

FIG. 11 is a signaling diagram illustrating a sidelink communication method 1100 according to some aspects of the present disclosure. The method 1100 may be implemented between a BS and two UEs, shown as a SL RX UE and a SL TX UE. The BS may be similar to the BSs 105, 305, and/or 600. The SL RX UE and the SL TX UE may be similar to the UEs 115, 315, and/or 500. The method 1100 is substantially similar to the scheme 700, but the SL RX UE may further provide channel information and/or any other control information to the BS to assist sidelink scheduling at the BS. As illustrated, the method 1100 includes a number of enumerated steps, but aspects of the method 1100 may include additional steps before, after, and in between the enumerated steps. In some aspects, one or more of the enumerated steps may be omitted or performed in a different order.

At step 1110, the SL RX UE determines sidelink channel sensing and measurements. The SL RX UE may perform sensing based on monitoring and/or decoding of SCIs transmitted by other UEs a PSCCH region of a sidelink resource pool (e.g., the resource pools 808, 908, and/or 1008) as discussed above. The SL RX UE may perform channel measurements based on CSI-RS transmitted by SL TX UEs from earlier sidelink communications. The SL RX UE may compute CQI, RSRP, and/or RSRQ from a signal received from the sidelink channel (e.g., in the resource pool). In some instances, the SL RX UE may utilize one or more components, such as the processor 502, the sidelink communication module 508, the transceiver 510, the modem 512, and the one or more antennas 516, to perform channel sensing and/or channel measurements.

At step 1120, the SL RX UE transmits control information related to sidelink communication to the BS, for example, via a PUCCH. The control information may include channel information, such as the channel sensing results and/or channel measurements. The control information may indicate which resource in the resource pool may be available or occupied, which subband may have a low interference or high interference, and/or how often a subband or resource within the resource pool may be occupied. In some instances, the SL RX UE may utilize one or more components, such as the processor 502, the sidelink communication module 508, the transceiver 510, the modem 512, and the one or more antennas 516, to transmit the control information.

At step 1130, the BS transmits DCI indicating a sidelink grant to the SL RX UE. The BS may determine the sidelink grant based on the control information (e.g., the channel sensing and/or measurement information) received from the SL RX UE. The BS may perform step 1130 using similar mechanisms as discussed in step 715.

At step 1140, the SL RX UE transmits SCI (e.g., the SCI 712) to the SL TX UE. The SCI may include scheduling information based on the sidelink grant. The SL RX UE may perform step 1140 using similar mechanisms as discussed in step 720.

At step 1150, the SL TX UE transmits sidelink data (e.g., the sidelink data 710) to the SL RX UE based on the scheduling indicated in the SCI. The SL TX UE may perform step 820 using similar mechanisms as discussed in step 730.

In some aspects, the SL RX UE may transmit the control information to the SL TX UE instead of the BS as shown at step 1120 and the SL TX UE may forward the control information to the BS. In some aspects, the BS may transmit the SL grant to the SL TX UE based on the control information received form the SL RX UE instead of transmitting the SL grant to the SL RX as shown at step 1130.

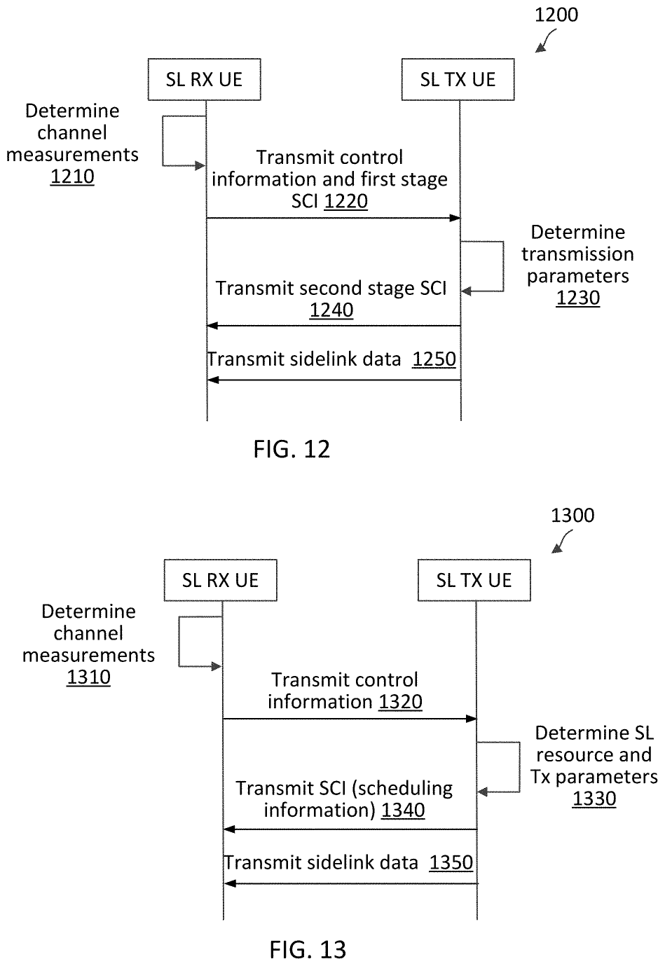

FIG. 12 is a signaling diagram illustrating a sidelink communication method 1200 according to some aspects of the present disclosure. The method 1200 may be implemented between a SL RX UE and a SL TX UE. The SL RX UE and the SL TX UE may be similar to the UEs 115, 315, and/or 500. As illustrated, the method 1200 includes a number of enumerated steps, but aspects of the method 1200 may include additional steps before, after, and in between the enumerated steps. In some aspects, one or more of the enumerated steps may be omitted or performed in a different order.

The method 1200 is substantially similar to the scheme 1000, but the SL RX UE may further provide channel information and/or any other control information to the SL TX UE to assist partial sidelink scheduling at the SL TX UE. Additionally, the method 1200 is substantially similar to the method 1100, where the SL RX UE may report channel and/or control information, but the channel and/or control information is sent to the SL TX UE instead of the BS.

At step 1210, the SL RX UE determines sidelink channel sensing and measurement, for example, using similar mechanisms as discussed above in step 1110.

At step 1220, the SL RX UE transmits control information and first stage SCI to the SL TX UE. The control information may include the determined sidelink sensing results and channel measurement as discussed with respect to step 1120 of the method 1100. The first stage SCI may be similar to the first stage SCI 912 and 1012. In some instances, the SL RX UE may utilize one or more components, such as the processor 502, the sidelink communication module 508, the transceiver 510, the modem 512, and the one or more antennas 516, to transmit the control information and the first stage SCI.

At step 1230, the SL TX UE determines transmission parameters, for example, using mechanisms as discussed above in step 1030.

At step 1240, the SL TX UE transmits a second stage SCI indicating the transmission parameters, for example, using mechanisms as discussed above in step 1040.

At step 1250, the SL TX UE transmits sidelink data to the SL RX UE based on the second stage SCI, for example, using mechanisms as discussed above in step 1050.

FIG. 13 is a signaling diagram illustrating a sidelink communication method 1300 according to some aspects of the present disclosure. The method 1300 may be implemented between a BS and two UEs, shown as a SL RX UE and a SL TX UE. The SL RX UE and the SL TX UE may be similar to the UEs 115, 315, and/or 500. As illustrated, the method 1300 includes a number of enumerated steps, but aspects of the method 1300 may include additional steps before, after, and in between the enumerated steps. In some aspects, one or more of the enumerated steps may be omitted or performed in a different order.

The method 1300 is substantially similar to the method 1200, where the SL RX UE may provide channel information and/or any other control information for sidelink communication to the SL TX UE, but scheduling information is determined by the SL TX UE.

At step 1310, the SL RX UE determines sidelink channel sensing results and measurements, for example, using similar mechanisms as discussed above in step 1210.

At step 1320, the SL RX UE transmits control information to the SL TX UE. The control information may include the sidelink channel sensing results and measurements. In some instances, the SL RX UE may utilize one or more components, such as the processor 502, the sidelink communication module 508, the transceiver 510, the modem 512, and the one or more antennas 516, to transmit the control information.

At step 1330, the SL TX UE determines sidelink resources and transmission parameters for sidelink data transmission. The SL TX UE may use substantially similar mechanisms as the SL RX UE in determining the sidelink resources and transmission parameters discussed above in step 815. However, the SL TX UE may perform the resource selection and/or the transmission parameter determination based on the control information (e.g., channel sensing and measurement information) provided by the SL RX UE instead of performing channel sensing and measurements by itself. Alternatively, the SL TX UE may perform the resource selection and/or the transmission parameter determination based on channel sensing and measurements perform at the SL TX UE in addition to the channel sensing and measurements reported by the SL RX UE. In some instances, the SL TX UE may utilize one or more components, such as the processor 502, the sidelink communication module 508, the transceiver 510, the modem 512, and the one or more antennas 516, to determine the sidelink resources and transmission parameters.

At step 1340, the SL TX UE transmits SCI to the SL RX UE. The SCI may indicate scheduling information including the determined sidelink resources and transmission parameters. In some instances, the SL TX UE may utilize one or more components, such as the processor 502, the sidelink communication module 508, the transceiver 510, the modem 512, and the one or more antennas 516, to transmit the SCI.

At step 1350, the SL TX UE transmits sidelink data to the SL RX UE based on the SCI. In some instances, the SL TX UE may utilize one or more components, such as the processor 502, the sidelink communication module 508, the transceiver 510, the modem 512, and the one or more antennas 516, to transmit the sidelink data.

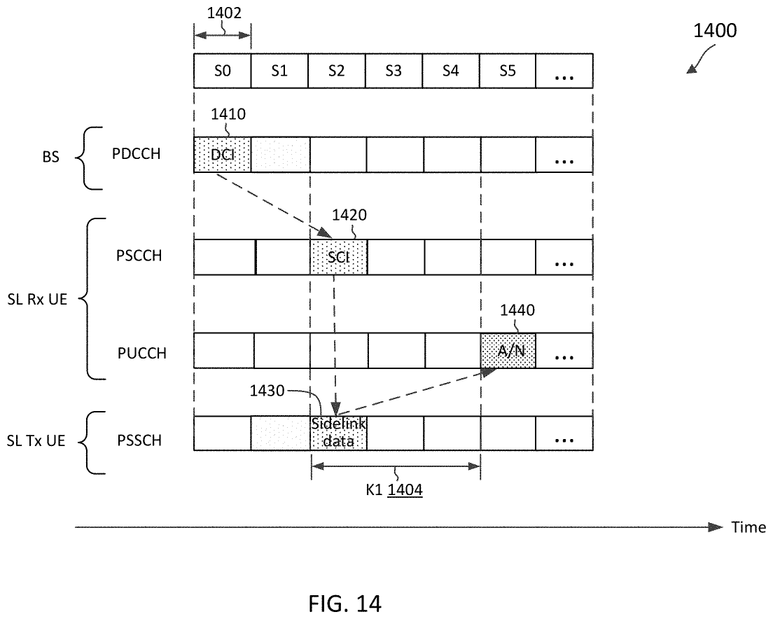

FIG. 14 illustrates a sidelink scheduling timeline 1400 according to some aspects of the present disclosure. The timeline 1400 may correspond to a sidelink scheduling timeline in the networks 100 and/or 300. In particular, a BS such as the BSs 105, 305, and/or 600 may schedule sidelink for a pair of SL UEs (a SL TX UE and a SL RX UE) such as the UEs 115, 315, and/or 500 as shown in the timeline 1400. For purposes of simplicity of illustration and discussion, FIG. 14 illustrates 6 slots 1402 similar to the slots 202. However, the timeline 1400 may include any suitable number of slots (e.g., about 7, 8, 9, or more). The slots 1402 are shown as S0 to S5. The pattern-filled boxes represent transmissions of DCI, SCI, sidelink data, and/or ACK/NACK in corresponding slots 202. While an entire slot 1402 is pattern-filled, a transmission may occur only in a corresponding portion of the slot 1402.

In the illustrated example of FIG. 14, at slot S0 1402, the BS transits a DCI 1410 to the SL RX UE via a PDCCH. The DCI 1410 may indicate a sidelink resource in the slot S2 1402.

At slot S2 1402, the SL RX UE transmits SCI 1420 (e.g., the SCIs 812, 912, and/or 914) indicating the sidelink resource in the slot S2 1402 via a PSCCH (e.g., the PSCCH 420).

Upon detecting the SCI 1420, the SL TX UE transmits sidelink data 1430 (e.g., the sidelink data 710, 810, 910, and/or 1010) in the slot S2 1402 according to the SCI 1420 via a PSSCH (e.g., the PSCCH 420) to the SL RX UE.

The BS may include a K1 parameter 1404 in the DCI 1410. The K1 parameter 1404 specifies a duration between the transmission of the sidelink data 1430 and the transmission of a corresponding ACK/NACK (A/N). In the illustrated example of FIG. 14, K1 equals to 3 slots 1402. The BS may also include a PUCCH resource indication in the DCI 1410 for transmitting an A/N.

After receiving the sidelink data 1430, the SL RX UE transmits an A/N 1440 to the BS via a PUCCH (in the slot 55 1402 based on the K1 parameter 1404 and using the indicated PUCCH resource). If the SL RX UE successfully decodes the sidelink data 1430, the SL RX UE may transmit an ACK. If the SL RX UE fails to decode the sidelink data 1430, the SL RX UE may transmit a NACK. The SL RX UE may report the A/N 1440 using a HARQ ACK codebook pre-configured by the BS. Upon receiving a NACK, the BS may provide the SL RX UE with another sidelink grant for retransmission.

In some aspects, the BS may determine the K1 parameter 1404 based on a PSSCH scheduling delay and decoding delay. When the BS transmits the DCI 1410 (carrying the sidelink grant) to the SL RX UE instead of the SL TX UE as in the conventional approach, the BS may budget a longer delay between the PDCCH to PSSCH timeline than when the sidelink grant is sent to the SL TX UE, but may budget a shorter delay between the PSCCH to PUCCH timeline. For instance, the PDCCH to PSSCH delay may be doubled when the SL TX UE receives the sidelink grant information via the SL RX UE instead of directly from the BS.

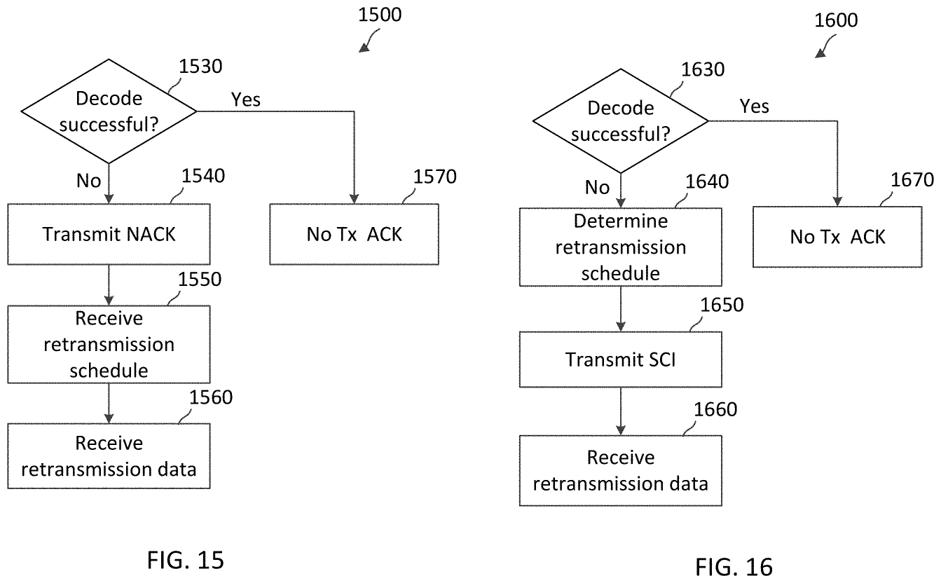

FIGS. 15-16 illustrate various mechanisms for implementing HARQ with a SL RX UE (e.g., the UEs 115, 315, and/or 500) initiating an initial transmission. FIG. 15 is a flow diagram of a sidelink communication method 1500 that implements HARQ according to some aspects of the present disclosure. Aspects of the method 1500 can be executed by a computing device (e.g., a processor, processing circuit, and/or other suitable component) of a wireless communication device or other suitable means for performing the steps. For example, a wireless communication device, such as the UE 115, 315, or 500, may utilize one or more components, such as the processor 502, the memory 504, the sidelink communication module 508, the transceiver 510, the modem 512, and the one or more antennas 516, to execute the steps of method 1500. As illustrated, the method 1500 includes a number of enumerated steps, but aspects of the method 1300 may include additional steps before, after, and in between the enumerated steps. In some aspects, one or more of the enumerated steps may be omitted or performed in a different order. The method 1500 may be used in conjunction with the schemes 700, 800, 900, and/or 1000 described with respect to FIGS. 7A-B, 8A-B, 9A-B, and/or 10A-B, respectively and the methods 1100, 1200, and/or 1330 described above with respect to FIGS. 11, 12, and/or 13, respectively. For instance, the method 1500 may be implemented by the SL RX UE (e.g., the UEs 115, 315, and/or 500) after SL RX UE receives sidelink data (e.g., the sidelink data 710, 810, 910, and/or 1010) from a SL TX UE (e.g., the UEs 115, 315, and/or 500). In the method 1500, the SL RX UE may not transmit an ACK if sidelink data decoding is successful and may transmit a NACK if sidelink data decoding fails so that the SL TX UE may schedule a retransmission.

At block 1530, the SL RX UE determines whether the sidelink data is decoded successfully. In some instances, the SL RX UE may utilize one or more components, such as the processor 502, the sidelink communication module 508, the transceiver 510, the modem 512, and the one or more antennas 516, to determine whether the sidelink data is decoded successfully. For instance, the SL RX UE may receive a signal from a sidelink resource, perform demodulation and decoding according to a MCS indicated by a corresponding sidelink schedule, and determine if there is any error from the decoding. If the SL RX UE determines that the decoding of the sidelink data fails, the UE may proceed to the block 1540.

At block 1540, the SL RX UE transmits a NACK to the SL TX UE. In some instances, the SL RX UE may utilize one or more components, such as the processor 502, the sidelink communication module 508, the transceiver 510, the modem 512, and the one or more antennas 516, to transmit the NACK. The NACK can be transmitted in a physical sidelink feedback channel (PSFCH), which may be in a different resource pool or the same resource pool as the PSSCH and PSCCH and may be preconfigured by a BS.

At block 1550, in response to the NACK, the SL RX UE receives a retransmission schedule from the SL TX UE. In some instances, the SL RX UE may utilize one or more components, such as the processor 502, the sidelink communication module 508, the transceiver 510, the modem 512, and the one or more antennas 516, to receive the retransmission schedule.

At block 1560, upon receiving the retransmission schedule, the SL RX UE receive the retransmitted sidelink data based on the retransmission schedule. In some instances, the SL RX UE may utilize one or more components, such as the processor 502, the sidelink communication module 508, the transceiver 510, the modem 512, and the one or more antennas 516, to receive the retransmitted sidelink data.

Returning to block 1530, if the SL RX UE determines that the sidelink data is decoded successfully, the SL RX UE may not transmit an ACK. The SL TX UE may assume that the sidelink data is received correctly at the SL RX UE when no ACK/NACK is received. In some instances, the SL RX UE may utilize one or more components, such as the processor 502, the sidelink communication module 508, the transceiver 510, the modem 512, and the one or more antennas 516, to refrain from generating any ACK/NACK.

FIG. 16 is a flow diagram of a sidelink communication method 1600 that implements HARQ according to some aspects of the present disclosure. Aspects of the method 1600 can be executed by a computing device (e.g., a processor, processing circuit, and/or other suitable component) of a wireless communication device or other suitable means for performing the steps. For example, a wireless communication device, such as the UE 115, 315, or 500, may utilize one or more components, such as the processor 502, the memory 504, the sidelink communication module 508, the transceiver 510, the modem 512, and the one or more antennas 516, to execute the steps of method 1600. As illustrated, the method 1600 includes a number of enumerated steps, but aspects of the method 1300 may include additional steps before, after, and in between the enumerated steps. In some aspects, one or more of the enumerated steps may be omitted or performed in a different order. The method 1600 may be used in conjunction with the schemes 700, 800, 900, and/or 1000 described with respect to FIGS. 7A-B, 8A-B, 9A-B, and/or 10A-B, respectively and the methods 1100, 1200, and/or 1330 described above with respect to FIGS. 11, 12, and/or 13, respectively. For instance, the method 1600 may be implemented by the SL RX UE (e.g., the UEs 115, 315, and/or 500) after SL RX UE receives sidelink data (e.g., the sidelink data 710, 810, 910, and/or 1010) from a SL TX UE (e.g., the UEs 115, 315, and/or 500).

Generally speaking, the method 1600 includes features similar to method 1500 in many respects. For example, blocks 1630, 1660, and 1670 are similar to blocks 1530, 1560, 1570, and 1278, respectively. Accordingly, for sake of brevity, details of those steps will not be repeated here. Please refer to the corresponding descriptions above. However, in the method 1600, the SL RX UE may determine a retransmission schedule and transmit another SCI if sidelink data decoding fails instead of transmitting a NACK as in the method 1500.

If, at block step 1630, the SL RX UE determines that the decoding of the sidelink data fails, the UE may proceed to block 1640.

At block 1640, the SL RX UE determines a retransmission schedule. The SL RX UE may determine the sidelink resource and/or transmission parameters for the retransmission using similar mechanisms as discussed above in steps 810 of FIG. 8.

At block 1650, the SL RX UE transmits SCI to the SL TX UE. The SCI may be similar to the SCIs 712, 812, 912, 914, 1012, and/or 1014. The SCI may indicate the retransmission schedule.

At block 1660, the SL RX UE receives sidelink data based on sidelink resource and/or transmission parameters indicated for the retransmission in the transmitted SCI.

Returning to block 1630, if the SL RX UE determines that the sidelink data is decoded successfully, the SL RX UE may not transmit an ACK. The SL TX UE may assume that the sidelink data is received correctly at the SL RX UE when no ACK/NACK is received. In some instances, the SL RX UE may utilize one or more components, such as the processor 502, the sidelink communication module 508, the transceiver 510, the modem 512, and the one or more antennas 516, to refrain from generating any ACK/NACK.

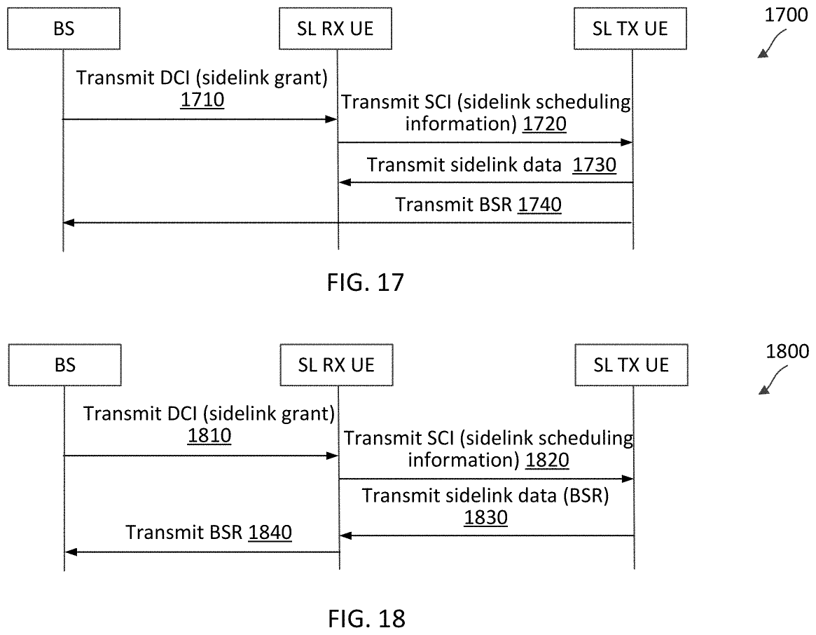

FIGS. 17-20 illustrate various mechanisms for indicating pending data at a SL TX UE (e.g., the UEs 115, 315, and/or 500) with a SL RX UE (e.g., the UEs 115, 315, and/or 500) initiating a sidelink transmission.

FIG. 17 is a signaling diagram illustrating a sidelink data pending indication scheme 1700 according to some aspects of the present disclosure. The method 1700 may be implemented between a BS and two UEs, shown as a SL RX UE and a SL TX UE. The BS may be similar to the BSs 105, 305, and/or 600. The SL RX UE and the SL TX UE may be similar to the UEs 115, 315, and/or 500. As illustrated, the method 1700 includes a number of enumerated steps, but aspects of the method 1700 may include additional steps before, after, and in between the enumerated steps. In some aspects, one or more of the enumerated steps may be omitted or performed in a different order.

Generally speaking, the method 1700 includes features similar to scheme 700 in many respects. For example, steps 1710, 1720, and 1730 are similar to steps 715, 720, 730, respectively. Accordingly, for sake of brevity, details of those steps will not be repeated here. Please refer to the corresponding descriptions above.

At step 1740, the SL TX UE transmits a BSR to the BS. The BSR may indicate remaining sidelink data pending at the SL TX UE for transmission to the SL RX UE. For instance, the SL TX UE may generate sidelink data for the SL RX UE. The SL TX UE may enqueue the sidelink data in a transmit buffer at a memory such as the memory 504. The SL TX UE may count a number of bytes of sidelink ready for transmission to the SL RX UE and include the byte count in the BSR. Thus, the BSR may operate as a scheduling request. The BS may respond by scheduling another sidelink grant for the SL RX UE so that the SL RX UE may initiate another transmission from the SL TX UE. Accordingly, the SL TX UE may transmit the pending data to the SL RX UE. In some instances, the SL RX UE may utilize one or more components, such as the processor 502, the sidelink communication module 508, the transceiver 510, the modem 512, and the one or more antennas 516, to determine the pending sidelink data count, generate the BSR based on the pending data count, and transmit the BSR to the BS.

In some aspects, the SL TX UE may transmit an SR to the BS instead of the BSR. The SR may include 1 bit. The SR-bit may be set to a value of 1 to indicate a scheduling request, for example, when there is pending data at the SL TX UE for transmission. Alternatively, the SR-bit may be set to a value of 0 to indicate no scheduling is requested.

FIG. 18 is a signaling diagram illustrating a sidelink data pending indication method 1800 according to some aspects of the present disclosure. The method 1800 may be implemented between a BS and two UEs, shown as a SL RX UE and a SL TX UE. The BS may be similar to the BSs 105, 305, and/or 600. The SL RX UE and the SL TX UE may be similar to the UEs 115, 315, and/or 500. As illustrated, the method 1800 includes a number of enumerated steps, but aspects of the method 1800 may include additional steps before, after, and in between the enumerated steps. In some aspects, one or more of the enumerated steps may be omitted or performed in a different order.

Generally speaking, the method 1800 includes features similar to method 1700 in many respects. For example, steps 1810, 1820, and 1830 are similar to steps 1710, 1720, 1730, respectively. Accordingly, for sake of brevity, details of those steps will not be repeated here. Please refer to the corresponding descriptions above.

However, at step 1830, the SL TX UE transmits the sidelink data along with a BSR to the SL RX UE. The SL TX UE may generate the BS using similar mechanisms as discussed above in step 1740. In some instances, the SL RX UE may utilize one or more components, such as the processor 502, the sidelink communication module 508, the transceiver 510, the modem 512, and the one or more antennas 516, to determine the pending sidelink data count, generate the BSR based on the pending data count, and transmit the BSR along with the sidelink data to the SL RX UE.

At step 1840, upon receiving the sidelink data and the BSR, the SL RX UE forwards the BSR to the BS. In some instances, the SL RX UE may utilize one or more components, such as the processor 502, the sidelink communication module 508, the transceiver 510, the modem 512, and the one or more antennas 516, to forward the BSR to the BS. Subsequently, the BS may respond by scheduling another sidelink grant for the SL RX UE so that the SL RX UE may initiate another transmission from the SL TX UE.

In some aspects, the SL TX UE may transmit an SR along with the sidelink data instead of a BSR along with the sidelink data at the step 1830.

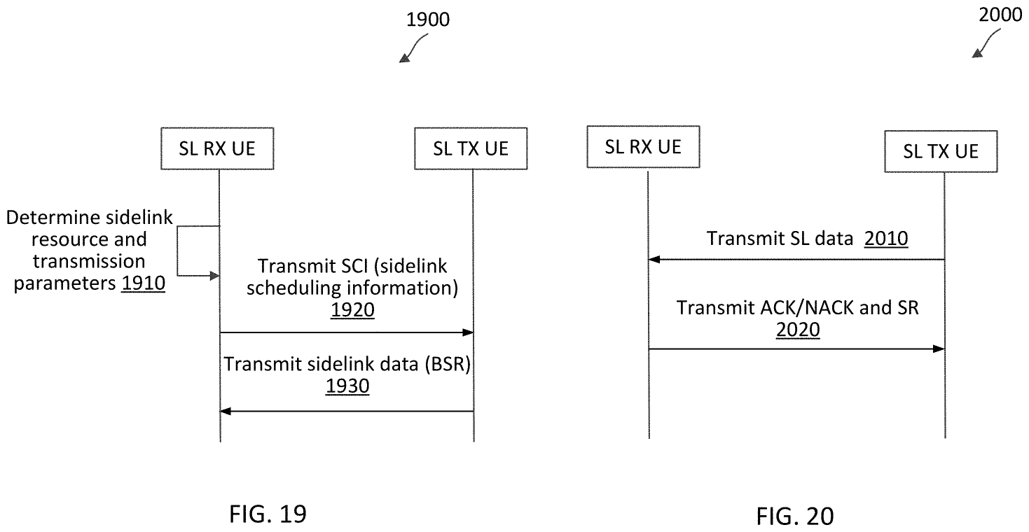

FIG. 19 is a signaling diagram illustrating a sidelink data pending indication method 1900 according to some aspects of the present disclosure. The method 1900 may be implemented between two UEs, shown as a SL RX UE and a SL TX UE. The SL RX UE and the SL TX UE may be similar to the UEs 115, 315, and/or 500. As illustrated, the method 1900 includes a number of enumerated steps, but aspects of the method 1900 may include additional steps before, after, and in between the enumerated steps. In some aspects, one or more of the enumerated steps may be omitted or performed in a different order.

Generally speaking, the method 1900 includes features similar to scheme 800 in many respects. For example, steps 1910, 1920, and 1930 are similar to steps 815, 820, 830, respectively. Accordingly, for sake of brevity, details of those steps will not be repeated here. Please refer to the corresponding descriptions above.

However, at step 1930, the SL TX UE transmits the sidelink data along with a BSR to the SL RX UE, using similar mechanism as discussed above in step 1830. Alternatively, the SL TX UE may include an SR in the sidelink data transmission instead of a BSR. Subsequently, the SL RX UE may schedule sidelink for the SL TX UE based on the BSR or the SR.

FIG. 20 is a signaling diagram illustrating a sidelink data pending indication method 2000 according to some aspects of the present disclosure. The method 2000 may be implemented between two UEs, referred to in the following as a sidelink (SL) UE A and a SL UE B. The SL UE A and the SL UE B may be similar to the UEs 115, 315, and/or 500. As illustrated, the method 2000 includes a number of enumerated steps, but aspects of the method 2000 may include additional steps before, after, and in between the enumerated steps. In some aspects, one or more of the enumerated steps may be omitted or performed in a different order.

In the method 2000, the SL UE A operate as a transmitter and the SL UE B may operate as a receiver initially and the SL UE B may subsequently have pending data. To facilitate scheduling by a receiving UE, the SL UE B may include an SR along with a ACK/NACK transmission.

In this regard, at step 2010, the SL UE A transmits sidelink data to the SL UE B. The sidelink data may be transmitted in a certain sidelink resource (e.g., the resources 406, 706, 806, 906, 1006) and using certain transmission parameters based on a certain schedule. The scheduling can be performed by a BS (e.g., the BSs 105, 305, and/or 600), the SL UE A, and/or the SL UE B, for example, using any of the schemes 700, 800, 900, and/or 1000 discussed above with respect to FIGS. 7, 8, 9, and/or 10, respectively and/or the methods 1100, 1200, and/or 1300 discussed above with respect to FIGS. 11, 12, and/or 13, respectively. In some instances, the SL UE A may utilize one or more components, such as the processor 502, the sidelink communication module 508, the transceiver 510, the modem 512, and the one or more antennas 516, to transmit the sidelink data to the SL UE B.

At step 2020, the SL TX B transmits an ACK/NACK and an SR to the SL RX A. The SL UE B may multiplex the ACK/NACAK with the SR in a PSFCH. The SL UE B may transmit an ACK if the sidelink data is decoded correctly. Alternatively, the SL UE B may transmit a NACK if the sidelink data decoding fails. The SL UE B may perform sidelink data decoding using similar mechanisms as the SL RX UE discussed above in the step 1530. The SR may be represented by a one-bit SR flag. The SL UE B may determine whether to set the SR flag to 1 or 0 based on whether the SL UE B has data pending for transmission to the SL RX A. The ACK/NACK may be transmitted in the form of a sequence selected from a HARQ ACK/NACK codebook. The SL UE B may multiplex the ACK/NACK sequence with the SR in time and/or frequency. In some instances, the SL UE B may utilize one or more components, such as the processor 502, the sidelink communication module 508, the transceiver 510, the modem 512, and the one or more antennas 516, to transmit the ACK/NAK multiplexed with the SR. Subsequently, upon receiving the SR, the SL UE A may schedule sidelink for the SL UE B to transmit the pending data to the SL UE B.

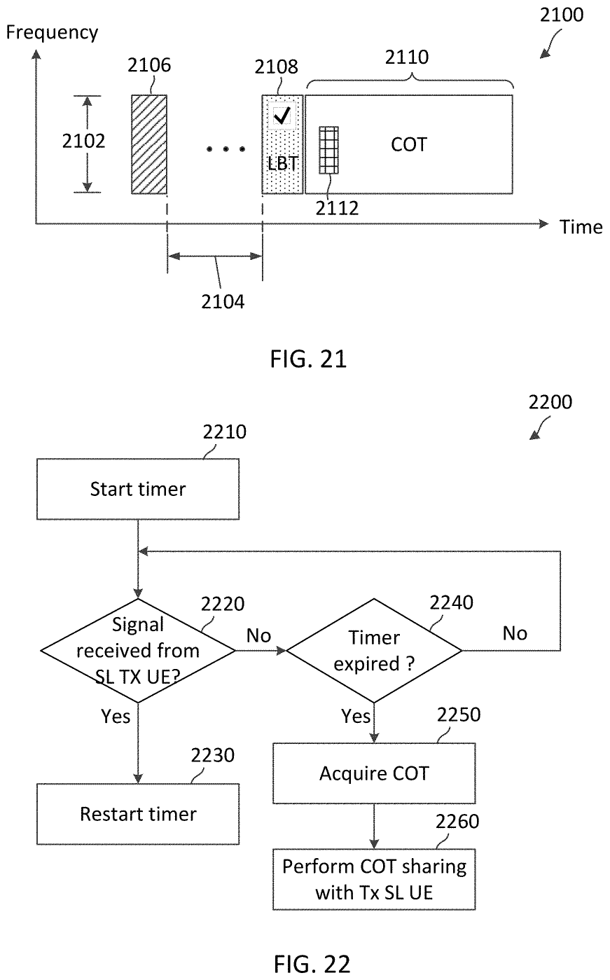

FIG. 21 illustrates a COT sharing scheme 2100 for sidelink communication according to some aspects of the present disclosure. The scheme 2100 may be employed by UEs such as the UEs 115 and 315 in a network such as the networks 100 and/or 300. In particular, the UEs may communicate with each other over a sidelink such as the sidelinks 351 and 352 as shown in the network 300. In FIG. 21, the x-axis represent time in some arbitrary units, and the y-axis represent frequency in some arbitrary units. In the scheme 2100, a SL RX UE (e.g., the UEs 115, 315, and/or 500) may contend for a COT in a shared radio frequency band or an unlicensed band to share with a SL TX UE (e.g., the UEs 115, 315, and/or 500) if the SL RX UE is aware that the SL TX UE has pending data and the SL RX UE fails to detect a signal from the SL TX UE.

In the scheme 2100, the SL RX UE and the SL TX UE may communicate over a frequency band 2102 shared by a plurality of network operating entities and/or a plurality of RATs. The frequency band 2102 may be located at any suitable frequencies. In some aspects, the frequency band 2102 may be a sub-6 GHz band or a mmWave band. The SL RX UE and the SL TX UE may communicate with each other based on a reverse link scheduling using any of the schemes 700, 800, 900, and/or 1000 discussed above with respect to FIGS. 7, 8, 9, and/or 10, respectively and/or the methods 1100, 1200, 1300, 1500, 1600, 1700, 1800, 1900, and/or 2000 discussed above with respect to FIGS. 11, 12, 13, 15, 16, 17, 18, 19, and/or 20, respectively. However, the SL RX UE and the SL TX UE may perform an LBT (e.g., a CAT4 LBT) prior to transmitting in the frequency band 2102. If the LBT is a success, the transmitting node (e.g., the SL RX UE or the SL TX UE) may proceed with the transmission in the frequency band 2102. If the LBT fails, the transmitting node refrain from transmitting in the frequency band 2102. The LBT can be based on energy detection or signal detection as discussed above with respect to FIG. 1.

In the illustrated example of FIG. 21, the SL TX UE transmits a data pending indication 2106 to indicate the SL RX UE that the SL TX UE has data pending for transmission to the SL RX UE. The SL TX UE may transmit the data pending indication 2106 via a BSR or an SR using mechanisms in the methods 1700-2000 discussed above with respect to FIGS. 17-20. After receiving the data pending indication 2106 from the SL TX UE, the SL RX UE may monitor for a transmission from the SL TX UE. The monitoring may include SCI monitoring and/or PSSCH DMRS monitoring.

Since transmission in the frequency band 2102 is based on LBT, the SL TX UE may or may not be able to access the frequency band 2102. For instance, the SL TX UE may contend for a COT by performing a CAT4 LBT, but the CAT4 LBT fails. If the SL RX UE does not detect any transmission from the SL TX UE after a period of time (e.g., a period 2104), the SL RX UE may contend for a COT and share the COT with the SL TX UE.

As shown, the SL RX UE fails to detect a transmission from the SL TX UE for a period 2104 since the last reception from the SL TX UE. After the period 2104 elapsed, the SL RX UE contends for a COT by performing an LBT 2108 (e.g., a CAT4 LBT). The LBT 2108 is a pass as shown by the checkmark. After winning the COT 2110, the SL RX UE shares the COT 2110 with the SL TX UE. In this regard, the SL RX UE transmits a COT indicator 2112. The COT indicator 2112 may include a COT sharing field indicating that the COT 2110 is being shared with another UE (e.g., the SL TX UE). The COT sharing field may be a 1-bit flag, where a value of 1 may indicate that COT 2110 is for sharing and a value of 0 may indicate that the COT 2110 is not for sharing. The COT indicator 2112 may operate as a reservation so that other transmitters contending in the frequency band 2102 may backoff The SL TX UE may detect the COT indicator 2112 with the COT sharing field indicating that sharing is enabled. Based on the sharing of the COT 2110, the SL TX UE may transmit pending data in the COT 2110 without performing an LBT. Alternatively, the SL TX UE may perform a CAT2 LBT within the COT 2110 and transmit the pending data within the COT 2110 based on a successful CAT2 LBT.

FIG. 22 is a flow diagram of a COT sharing method 2200 for sidelink communication according to some aspects of the present disclosure. Aspects of the method 2200 can be executed by a computing device (e.g., a processor, processing circuit, and/or other suitable component) of a wireless communication device or other suitable means for performing the steps. For example, a wireless communication device, such as the UE 115, 315, or 500, may utilize one or more components, such as the processor 502, the memory 504, the sidelink communication module 508, the transceiver 510, the modem 512, and the one or more antennas 516, to execute the steps of method 2200. As illustrated, the method 2200 includes a number of enumerated steps, but aspects of the method 2200 may include additional steps before, after, and in between the enumerated steps. In some aspects, one or more of the enumerated steps may be omitted or performed in a different order. The method 2200 may be used in conjunction with the scheme 2100 described with respect to FIG. 21 when communicating sidelink over a shared radio frequency band (e.g., the frequency band 2102). For instance, the method 2200 may be implemented by a SL RX UE (e.g., the UEs 115, 315, and/or 500) after receiving a sidelink data pending indication (e.g., the data pending indication 2106) from a SL TX UE (e.g., the UEs 115, 315, and/or 500).

At block 2210, the SL RX UE starts a timer after receiving sidelink data pending indication. For instance, the SL RX UE may configure a timer or counter based on a certain period (e.g., the period 2104) and start the timer or counter to count up or count down depending on the implementation of the timer or counter. In some instances, the timer or counter may be a hardware timer module coupled to a processor (e.g., the processor 502) of the SL RX UE.

At block 2220, the SL RX UE determines whether a signal is received from the SL TX UE. In this regard, the SL RX UE may receive signal from the shared radio frequency band. The SL RX UE may determine whether the received signal includes SCI transmitted by the SL TX UE based on whether SCI decoding on the received signal passes or fails. The SL RX UE may determine whether the received signal includes a PSSCH DMRS transmitted by the SL RX UE based on whether a signal measurement on the received signal passes a certain threshold. In some instances, the SL RX UE may utilize one or more components, such as the processor 502, the sidelink communication module 508, the transceiver 510, the modem 512, and the one or more antennas 516, to determine whether a signal is received from the SL TX UE. If the SL RX UE fails to receive a signal from the SL TX UE, the SL RX UE proceeds to block 2240.

At block 2240, the SL RX UE determines whether the timer has expired. If the timer has expired, the SL RX UE proceeds to block 2250. For instance, the SL RX UE may determine whether the timer has expired based on a remaining count or time in the timer. Alternatively, the timer may send an interrupt signal to a processor (e.g., the processor 502) of the SL RX UE to notify the timer expiration.

At block 2250, the SL RX UE acquires a COT (e.g., the COT 2110) by performing a CAT4 LBT (e.g., the LBT 2108) as discussed above.

At block 2260, after acquiring the COT, the SL RX UE performs COT sharing with the TX SL UE. For instance, the SL RX UE may transmit a COT indicator (e.g., the COT indicator 2112) indicating that the COT is for sharing (e.g., by setting a COT sharing flag to 1). In some instances, the SL RX UE may also transmit sidelink discovery information (e.g., synchronization signals and/or discovery announcement messages for establishing sidelink communications) within the COT.

Returning to block 2220, if the SL RX UE received a signal from the SL TX UE (e.g., SCI, sidelink data, and/or PSSCH DMRS), the SL RX UE proceeds to block 2230.

At block 2230, the SL RX UE restarts the timer. For instance, the SL RX UE may reinitialize the timer based on the expiration period (e.g., the period 2104).

In some aspects, while the method 2200 is described in the context of the SL RX UE starting the timer based on receiving a BSR or an SR from the SL TX UE, the SL RX UE may start or reinitialize the timer based on receiving a transmission from the SL TX UE or a BS (e.g., the BSs 105, 305, and/or 600). The SL RX UE may determine the time expiration period based on various conditions or triggers for sharing a COT. For instance, the SL RX UE may configure the timer with different expiration periods based on whether the SL RX UE expects data from the BS or the SL TX UE, whether the SL RX UE has received an indication regarding data pending at the SL TX UE or the BS, and/or whether the last reception is associated with control information or data. In general, the SL RX UE may contend for a COT to share with SL TX UE and/or the BS and/or the SL RX UE. For instance, the SL RX UE may share the COT with the SL TX UE so that the SL TX UE may transmit sidelink data to the SL RX UE. Alternatively, the SL RX UE may share the COT with the BS so that the BS may schedule the SL TX UE to transmit sidelink data to the SL RX UE.

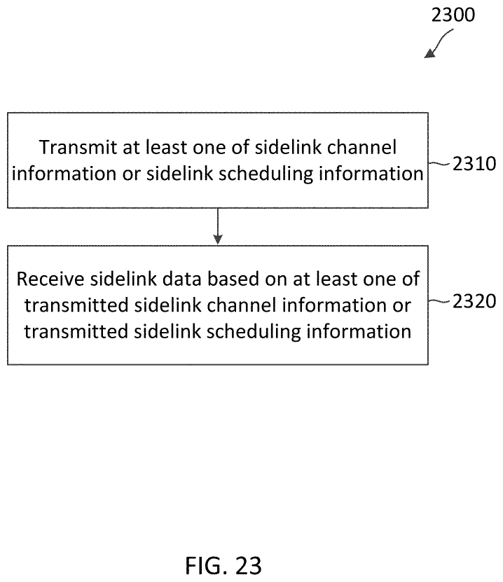

FIG. 23 is a flow diagram of a communication method 2300 according to some aspects of the present disclosure. Aspects of the method 2300 can be executed by a computing device (e.g., a processor, processing circuit, and/or other suitable component) of a wireless communication device or other suitable means for performing the steps. For example, a wireless communication device, such as the UE 115, 315, or 500, may utilize one or more components, such as the processor 502, the memory 504, the sidelink communication module 508, the transceiver 510, the modem 512, and the one or more antennas 516, to execute the steps of method 2300. The method 2300 may employ similar mechanisms as in the schemes 700, 800, 900, and/or 1000 discussed above with respect to FIGS. 7A-7B, 8A-8B, 9A-9B, and/or 10A-10B, respectively, the methods 1100, 1200, 1300, 1500, 1600, 1700, 1800, 1900, 2000 discussed above with respect to FIGS. 11, 12, 13, 15, 16, 17, 18, 19, and/or 20, respectively, and/or the timeline 1400 discussed above with respect to FIG. 14. As illustrated, the method 2300 includes a number of enumerated steps, but aspects of the method 2300 may include additional steps before, after, and in between the enumerated steps. In some aspects, one or more of the enumerated steps may be omitted or performed in a different order.

At block 2310, a first UE (e.g., the UEs 115, 315, and/or 500) transmits at least one of sidelink channel information or a sidelink scheduling information. In some instances, the first UE may utilize one or more components, such as the processor 502, the sidelink communication module 508, the transceiver 510, the modem 512, and the one or more antennas 516, to transmit at least one of the sidelink channel information or the sidelink scheduling information

At block 2320, the first UE receives, from a second UE (e.g., the UEs 115, 315, and/or 500), sidelink data based on at least one of the transmitted sidelink channel information or the transmitted sidelink scheduling information. In some instances, the first UE may utilize one or more components, such as the processor 502, the sidelink communication module 508, the transceiver 510, the modem 512, and the one or more antennas 516, to receive sidelink data based on at least one of the transmitted sidelink channel information or the transmitted sidelink scheduling information.

In some aspects, the first UE may correspond to the SL RX UE and the second UE may correspond to the SL TX UE in the schemes 700, 800, 900, and/or 1000 discussed above with respect to FIGS. 7A-7B, 8A-8B, 9A-9B, and/or 10A-10B, respectively, the methods 1100, 1200, 1300, 1500, 1600, 1700, 1800, 1900, and/or 2000 discussed above with respect to FIGS. 11, 12, 13, 15, 16, 17, 18, 19, and/or 20, respectively, and/or the timeline 1400 discussed above with respect to FIG. 14. In some aspects, first UE may transmit the sidelink scheduling information to the second UE in the form of SCI (e.g., the SCIs 712, 812, 912, 914, 1012, 1014) via a PSCCH (e.g., the PSCCH 420) and receive the sidelink data from the second UE via a PSSCH (e.g., the PSSCH 410). In some aspects, the first UE may transmit the sidelink scheduling information using a 2-stage SCI, for example, a first stage SCI (e.g., the SCI 912) indicating general resource allocation or reservation to facilitate sensing and a second stage SCI (e.g., the SCI 914) indicating more specific transmission parameters (e.g., MCS, DMRS pattern) for the sidelink data. As similarly explained above, the first UE being a receive sidelink UE may have a more accurate estimate of the channel condition and/or interference at the receiver of the first UE, and thus may determine more suitable resource and/or transmission parameters for receiving the sidelink data. In some aspects, the first UE may transmit the first stage SCI (e.g., the SCI 1012) and receive the second stage SCI (e.g., the SCI 1014) from the second UE. As similarly explained above, the first UE can provide the second UE with channel quality report and allow the second UE to determine transmission parameters for transmitting the sidelink data to the first UE. In some aspects, the first UE may receive a sidelink grant from a BS may transmit the sidelink scheduling information based on the sidelink grant. In some aspects, the first UE may receive a data pending indication from the second UE and may determine the sidelink scheduling information in response to the data pending indication. In some aspects, the first UE may transmit the channel information (e.g., including a CQI and/or channel sensing information) to the second UE and/or the BS.

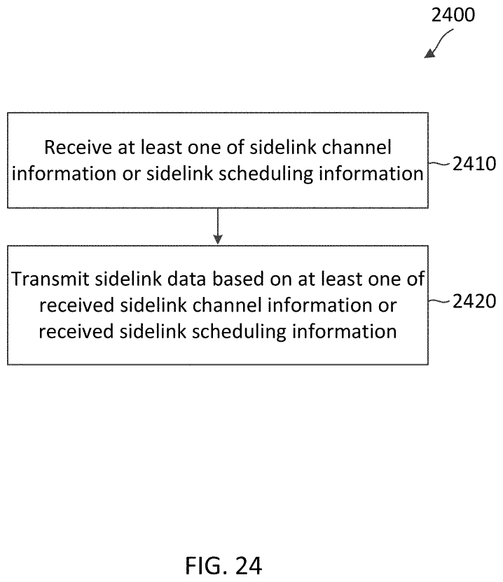

FIG. 24 is a flow diagram of a communication method 2400 according to some aspects of the present disclosure. Aspects of the method 2400 can be executed by a computing device (e.g., a processor, processing circuit, and/or other suitable component) of a wireless communication device or other suitable means for performing the steps. For example, a wireless communication device, such as the UE 115, 315, or 500, may utilize one or more components, such as the processor 502, the memory 504, the sidelink communication module 508, the transceiver 510, the modem 512, and the one or more antennas 516, to execute the steps of method 2300. The method 2400 may employ similar mechanisms as in the schemes 700, 800, 900, and/or 1000 discussed above with respect to FIGS. 7A-7B, 8A-8B, 9A-9B, and/or 10A-10B, respectively, the methods 1100, 1200, 1300, 1500, 1600, 1700, 1800, 1900, and/or 2000 discussed above with respect to FIGS. 11, 12, 13, 15, 16, 17, 18, 19, and/or 20, respectively, and/or the timeline 1400 discussed above with respect to FIG. 14. As illustrated, the method 2400 includes a number of enumerated steps, but aspects of the method 2400 may include additional steps before, after, and in between the enumerated steps. In some aspects, one or more of the enumerated steps may be omitted or performed in a different order.

At block 2410, a first UE (e.g., the UEs 115, 315, and/or 500) receives, from a second UE (e.g., the UEs 115, 315, and/or 500), at least one of sidelink channel information or a sidelink scheduling information. In some instances, the first UE may utilize one or more components, such as the processor 502, the sidelink communication module 508, the transceiver 510, the modem 512, and the one or more antennas 516, to receive at least one of the sidelink channel information or the sidelink scheduling information.

At step block 2420, the first UE transmits, to the second UE, sidelink data based on at least one of the received sidelink channel information or the received sidelink scheduling information. In some instances, the first UE may utilize one or more components, such as the processor 502, the sidelink communication module 508, the transceiver 510, the modem 512, and the one or more antennas 516, to transmit the sidelink data based on at least one of the received sidelink channel information or the received sidelink scheduling information.

In some aspects, the first UE may correspond to the SL TX UE and the second UE may correspond to the SL RX UE in the schemes 700, 800, 900, and/or 1000 discussed above with respect to FIGS. 7A-7B, 8A-8B, 9A-9B, and/or 10A-10B, respectively, the methods 1100, 1200, 1300, 1500, 1600, 1700, 1800, 1900, and/or 2000 discussed above with respect to FIGS. 11, 12, 13, 15, 16, 17, 18, 19, and/or 20, respectively, and/or the timeline 1400 discussed above with respect to FIG. 14. In some aspects, first UE may receive the sidelink scheduling information from the second UE in the form of SCI (e.g., the SCIs 712, 812, 912, 914, 1012, 1014) via a PSCCH (e.g., the PSCCH 420) and transmit the sidelink data from the second UE via a PSSCH (e.g., the PSSCH 410). In some aspects, the first UE may receive the sidelink scheduling information in the form of 2-stage SCI, for example, a first stage SCI (e.g., the SCI 912) indicating general resource allocation or reservation to facilitate sensing and a second stage SCI (e.g., the SCI 914) indicating more specific transmission parameters (e.g., MCS, DMRS pattern) for the sidelink data. In some aspects, the first UE may receive the first stage SCI (e.g., the SCI 1012), determine transmission parameters for the sidelink data, and transmits the second stage SCI (e.g., the SCI 1014) to the second UE. In some aspects, the first UE may transmit a data pending indication to the second UE and may receive the sidelink scheduling information in response to the data pending indication. In some aspects, the first UE may receive the channel information (e.g., including a CQI and/or channel sensing information) from the second UE.

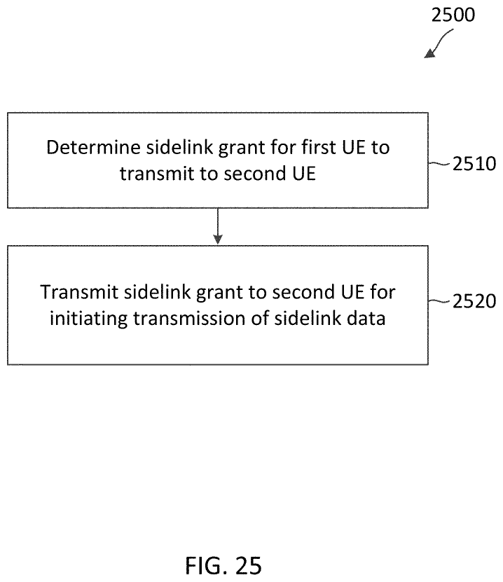

FIG. 25 is a flow diagram of a communication method 2500 according to some aspects of the present disclosure. Aspects of the method 2500 can be executed by a computing device (e.g., a processor, processing circuit, and/or other suitable component) of a wireless communication device or other suitable means for performing the steps. For example, a wireless communication device, such as the BS 105 or 600, may utilize one or more components, such as the processor 602, the memory 604, sidelink configuration module 608, the transceiver 610, the modem 612, and the one or more antennas 616, to execute the steps of method 2500. The method 2500 may employ similar mechanisms as in the schemes 700 discussed above with respect to FIGS. 7A-7B and/or the methods 1100, 1700, and/or 1800 discussed above with respect to FIGS. 11, 17, and/or 18, respectively. As illustrated, the method 2500 includes a number of enumerated steps, but aspects of the method 2500 may include additional steps before, after, and in between the enumerated steps. In some aspects, one or more of the enumerated steps may be omitted or performed in a different order.

At block 2510, a BS (e.g., the BSs 105, 305, and/or 600), determine a sidelink grant for a first UE (e.g., the UEs 115, 315, and/or 500) to transmit sidelink data to a second UE (e.g., the UEs 115, 315, and/or 500). For instance, the BS may determine a certain set of resources that may be used for sidelink communications and select a resource from the set of resources based on channel quality reports received from the first UE and/or the second UE. The BS may select a resource that can provide a good channel quality to the first UE and/or the second UE. In some instances, the BS may utilize one or more components, such as the processor 602, the sidelink configuration module 608, the transceiver 610, the modem 612, and the one or more antennas 616, to determine the sidelink grant.

At block 2520, the BS transmits, to the second UE, the sidelink grant for initiating a transmission of the sidelink data. In some instances, the BS may utilize one or more components, such as the processor 602, the sidelink configuration module 608, the transceiver 610, the modem 612, and the one or more antennas 616, to transmit the sidelink grant to the second UE.

In some aspects, the BS, the first UE, and the second UE may correspond to the BS, the SL TX UE, and the SL RX UE in the schemes 700 discussed above with respect to FIGS. 7A-7B and/or the methods 1100, 1700, and/or 1800 discussed above with respect to FIGS. 11, 17, and/or 18, respectively. In some aspects, the BS may receive a sidelink data pending indication from the first UE or the second UE and may determine the sidelink grant in response to the sidelink data pending indication. In some aspects, the BS may receive sidelink channel information (e.g., CQIs and/or channel sensing information) from the second UE and may determine the sidelink grant based on the sidelink channel information. In some aspects, the BS may receive an ACK/NACK for the sidelink data from the second UE. In some aspects, the BS may determine the sidelink grant considering a transmission delay between the BS and the second UE and a transmission delay between the first UE and the second UE.

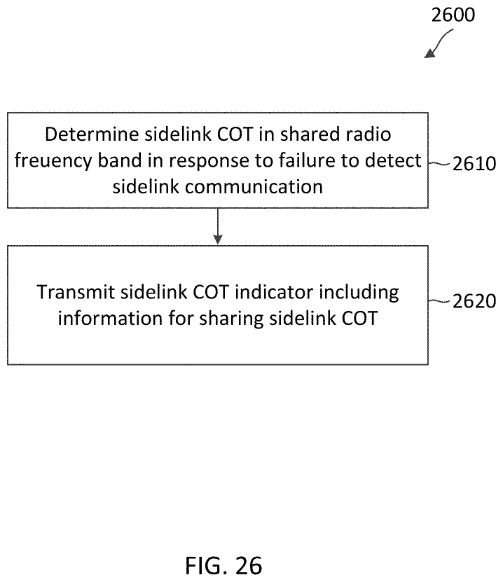

FIG. 26 is a flow diagram of a communication method 2600 according to some aspects of the present disclosure. Aspects of the method 2600 can be executed by a computing device (e.g., a processor, processing circuit, and/or other suitable component) of a wireless communication device or other suitable means for performing the steps. For example, a wireless communication device, such as the UE 115, 315, or 500, may utilize one or more components, such as the processor 502, the memory 504, the sidelink communication module 508, the transceiver 510, the modem 512, and the one or more antennas 516, to execute the steps of method 2600. The method 2600 may employ similar mechanisms as in the schemes 2100 discussed above with respect to FIG. 21 and/or the method 2200 discussed above with respect to FIG. 22. As illustrated, the method 2600 includes a number of enumerated steps, but aspects of the method 2600 may include additional steps before, after, and in between the enumerated steps. In some aspects, one or more of the enumerated steps may be omitted or performed in a different order.

At block 2610, a first UE determines a sidelink COT (e.g., the COT 2110) in a shared radio frequency band (e.g., the frequency band 2102) in response to a failure to detect a sidelink communication (e.g., the SCIs 712, 812, 912, 914, 1012, 1014 and/or sidelink data 710, 810, 910, and/or 1010). The first UE may perform a CAT4 LBT (e.g., the LBT 2108) based on energy detection and/or signal detection in the shared radio frequency band to acquire the sidelink COT. In some instances, the first UE may utilize one or more components, such as the processor 502, the sidelink communication module 508, the transceiver 510, the modem 512, and the one or more antennas 516, to determine the sidelink COT in response to failure to detect the sidelink communication.

At block 2620, the first UE transmits, to a second UE, a sidelink COT indicator (e.g., the COT indicator 2112) including information for sharing the sidelink COT. In some instances, the first UE may utilize one or more components, such as the processor 502, the sidelink communication module 508, the transceiver 510, the modem 512, and the one or more antennas 516, to transmit the COT indicator.

In some aspects, the first UE may determine the sidelink COT based on receiving a sidelink data pending indication from the second UE. In some aspects, the first UE may determine the sidelink COT based on a timer. For instance, the first UE may start and/or restart the timer based on receiving a transmission from the second UE or a BS (e.g., the BSs 105, 305, and/or 600). The first UE may configure the timer with an expiration period that is dependent on whether the first UE is expecting a transmission from the second UE or from the BS and/or whether the last transmission received from the BS or the second UE is a control signal or data.

Further aspects of the present disclosure include a method of wireless communication. The method of wireless communication includes transmitting, by a first user equipment (UE), at least one of sidelink channel information or a sidelink scheduling information; and receiving, by the first UE from a second UE, sidelink data based on at least one of the transmitted sidelink channel information or the transmitted sidelink scheduling information.

The method may also include one or more of the following features. For instance, the method includes where the transmitting includes transmitting, by the first UE to the second UE, the sidelink scheduling information including a resource allocation for transmitting the sidelink data. The transmitting the sidelink scheduling information includes transmitting, by the first UE to the second UE, a transmission parameter including at least one of a modulation coding scheme (MCS) or a demodulation reference signal (DMRS) pattern for the sidelink data. The transmitting the sidelink scheduling information includes transmitting, by the first UE to the second UE in a physical sidelink control channel (PSCCH), the resource allocation; and transmitting, by the first UE to the second UE in at least one of the PSCCH or a physical sidelink shared channel (PSSCH), the transmission parameter. The transmitting the sidelink scheduling information further includes transmitting, by the first UE to the second UE in a physical sidelink control channel (PSCCH), a resource allocation for the sidelink data; and the method further includes receiving, by the first UE from the second UE in at least one of the PSCCH or a physical sidelink shared channel (PSSCH), a transmission parameter including at least one of a modulation coding scheme (MCS) or a demodulation reference signal (DMRS) pattern for the sidelink data. The method may include determining, by the first UE, the sidelink scheduling information based on channel sensing. The method may include performing, by the first UE, the channel sensing based on sidelink control information (SCI) decoding. The transmitting includes transmitting, by the first UE, the sidelink channel information including at least one of a channel quality indicator or channel sensing information. The method may include receiving, by the first UE, at least one of a resource allocation or a transmission parameter for the sidelink data based on the sidelink channel information. The transmitting further includes transmitting, by the first UE to the second UE, the sidelink scheduling information based on the received sidelink grant. The method may include transmitting, by the first UE to the BS, an acknowledgement/negative-acknowledgement (ACK/NACK) for the sidelink data received from the second UE. The method may include transmitting, by the first UE to the second UE, a retransmission schedule for the sidelink data. The transmitting includes transmitting, by the first UE to the second UE, the sidelink scheduling information in response to a sidelink data pending indication. The method may include receiving, by the first UE from the second UE, another sidelink data multiplexed with the sidelink data pending indication. The method may include transmitting, by the first UE to the second UE, another sidelink data; and receiving, by the first UE from the second UE, an acknowledgement/negative-acknowledgement (ACK/NACK) feedback for the another sidelink data multiplexed with the sidelink data pending indication. The transmitting includes transmitting, by the first UE to the second UE, the sidelink scheduling information indicating a first resource for transmitting the sidelink data; and the method further includes transmitting, by the first UE to a third UE different from the second UE, an indication of a second resource for transmitting another sidelink data, where the second resource is multiplexed with the first resource in at least one of a time domain, a frequency domain, or a spatial domain.

Further aspects of the present disclosure include a method of wireless communication. The method of wireless communication includes receiving, by a first user equipment (UE) from a second UE, at least one of sidelink channel information or a sidelink scheduling information; and transmitting, by the first UE to the second UE, sidelink data based on at least one of the received sidelink channel information or the received sidelink scheduling information.

The method may also include one or more of the following features. For instance, the method includes where the receiving includes receiving, by the first UE from the second UE, the sidelink scheduling information including a resource allocation for transmitting the sidelink data. The receiving the sidelink scheduling information includes receiving, by the first UE from the second UE, a transmission parameter including at least one of a modulation coding scheme (MCS) or a demodulation references signal (DMRS) pattern for the sidelink data. The receiving the sidelink scheduling information includes receiving, by the first UE from the second UE in a physical sidelink control channel (PSCCH), the resource allocation; and receiving, by the first UE from the second UE in at least one of the PSCCH or a physical sidelink shared channel (PSSCH), the transmission parameter. The receiving the sidelink scheduling information further includes receiving, by the first UE from the second UE in a physical sidelink control channel (PSCCH), a resource allocation for the sidelink data; and the method further includes transmitting, by the first UE to the second UE in at least one of the PSCCH or a physical sidelink shared channel (PSSCH), a transmission parameter including at least one of a modulation coding scheme (MCS) or a demodulation references signal (DMRS) pattern for the sidelink data. The receiving includes receiving, by the first UE from the second UE, the sidelink channel information including at least one of a channel quality indicator or channel sensing information. The method may include transmitting, by the first UE to the second UE, at least one of a resource allocation or a transmission parameter for the sidelink data based on the received sidelink channel information. The receiving includes receiving, by the first UE from the second UE, the sidelink scheduling information in response to the sidelink data pending indication. The transmitting sidelink data pending indication includes transmitting, by the first UE to the second UE, another sidelink data multiplexed with the sidelink data pending indication. The transmitting sidelink data pending indication includes transmitting, by the first UE to the second UE, an acknowledgement/negative-acknowledgement (ACK/NACK) feedback for the another sidelink data multiplexed with the sidelink data pending indication.

Further aspects of the present disclosure include a method of wireless communication. The method of wireless communication includes determining, by a base station (BS), a sidelink grant for a first user equipment (UE) to transmit sidelink data to a second UE; and transmitting, by the BS to the second UE, the sidelink grant for initiating a transmission of the sidelink data.

The method may also include one or more of the following features. For instance, the method includes may include receiving, by the BS from the second UE, sidelink channel information associated with the first UE and the second UE, where the determining is further based on the sidelink channel information. The determining is further based on the sidelink data pending indication. The determining is further based on the sidelink data pending indication. The method may include receiving, by the BS from the second UE, an acknowledgement/negative-acknowledgement (ACK/NACK) for the sidelink data. The determining is further based on a transmission delay between the BS and the second UE and a transmission delay between the second UE and the first UE.

Further aspects of the present disclosure include a method of wireless communication. The method of wireless communication includes determining, by a first user equipment (UE), a sidelink channel occupancy time (COT) in a shared radio frequency band in response to failure to detect a sidelink communication; and transmitting, by the first UE to a second UE, a sidelink COT indicator including information for sharing the sidelink COT.

The method may also include one or more of the following features. For instance, the method may include receiving, by the first UE from the second UE, a sidelink data pending indication, where the determining is further based on the sidelink data pending indication. The determining is further based on a timer. The timer is associated with a time when the first UE receives a communication from the second UE or a base station (BS). The method may include determining, by the first UE, a time period for the timer based on whether the communication includes data or control information. The method may include determining, by the first UE, a time period for the timer based on whether the first UE expect data from the second UE or the BS.

Further aspects of the present disclosure include a first user equipment (UE) including a transceiver configured to transmit at least one of sidelink channel information or a sidelink scheduling information; and receive, from a second UE, sidelink data based on at least one of the transmitted sidelink channel information or the transmitted sidelink scheduling information.

The first UE may also include one or more of the following features. For instance, the first UE includes where the transceiver configured to transmit the at least one of the sidelink channel information or the sidelink scheduling information is configured to transmit, to the second UE, the sidelink scheduling information including a resource allocation for transmit the sidelink data. The transceiver configured to transmit the sidelink scheduling information is configured to transmit, to the second UE, a transmission parameter including at least one of a modulation coding scheme (MCS) or a demodulation reference signal (DMRS) pattern for the sidelink data. The transceiver configured to transmit the sidelink scheduling information is configured to transmit, to the second UE in a physical sidelink control channel (PSCCH), the resource allocation; and transmit, to the second UE in at least one of the PSCCH or a physical sidelink shared channel (PSSCH), the transmission parameter. The transceiver configured to transmit the sidelink scheduling information is configured to transmit, to the second UE in a physical sidelink control channel (PSCCH), a resource allocation for the sidelink data; and the transceiver is further configured to receive, from the second UE in at least one of the PSCCH or a physical sidelink shared channel (PSSCH), a transmission parameter including at least one of a modulation coding scheme (MCS) or a demodulation reference signal (DMRS) pattern for the sidelink data. The first UE may include a processor configured to determine the sidelink scheduling information based on channel sensing. The processor is further configured to perform the channel sensing based on sidelink control information (SCI) decoding. The transceiver configured to transmit the at least one of the sidelink channel information or the sidelink scheduling information is configured to transmit, the sidelink channel information including at least one of a channel quality indicator or channel sensing information. The transceiver is further configured to receive at least one of a resource allocation or a transmission parameter for the sidelink data based on the sidelink channel information. The transceiver is further configured to receive, from a base station (BS), a sidelink grant, where the transceiver configured to transmit the at least one of the sidelink channel information or the sidelink scheduling information is configured to transmit, to the second UE, the sidelink scheduling information based on the received sidelink grant. The transceiver is further configured to transmit, to the BS, an acknowledgement/negative-acknowledgement (ACK/NACK) for the sidelink data received from the second UE. The transceiver is further configured to transmit, to the second UE, a retransmission schedule for the sidelink data. The transceiver configured to transmit the at least one of the sidelink channel information or the sidelink scheduling information is configured to transmit, to the second UE, the sidelink scheduling information in response to a sidelink data pending indication. The transceiver is further configured to receive, from the second UE, another sidelink data multiplexed with the sidelink data pending indication. The transceiver is further configured to transmit, to the second UE, another sidelink data; and receive, from the second UE, an acknowledgement/negative-acknowledgement (ACK/NACK) feedback for the another sidelink data multiplexed with the sidelink data pending indication. The transceiver configured to transmit the at least one of the sidelink channel information or the sidelink scheduling information is configured to transmit, to the second UE, the sidelink scheduling information indicating a first resource for transmit the sidelink data; and the transceiver is further configured to transmit, to a third UE different from the second UE, an indication of a second resource for transmit another sidelink data, where the second resource is multiplexed with the first resource in at least one of a time domain, a frequency domain, or a spatial domain.

Further aspects of the present disclosure include a first user equipment (UE) including a transceiver configured to receive, from a second UE, at least one of sidelink channel information or a sidelink scheduling information; and transmit, to the second UE, sidelink data based on at least one of the received sidelink channel information or the received sidelink scheduling information.

The first UE may also include one or more of the following features. For instance, the first UE includes where the transceiver configured to receive the at least one of the sidelink channel information or the sidelink scheduling information is configured to receive, from the second UE, the sidelink scheduling information including a resource allocation for transmit the sidelink data. The transceiver configured to receive the sidelink scheduling information is configured to receive, from the second UE, a transmission parameter including at least one of a modulation coding scheme (MCS) or a demodulation references signal (DMRS) pattern for the sidelink data. The transceiver configured to receive the sidelink scheduling information is configured to receive, from the second UE in a physical sidelink control channel (PSCCH), the resource allocation; and receive, from the second UE in at least one of the PSCCH or a physical sidelink shared channel (PSSCH), the transmission parameter. The transceiver configured to receive the sidelink scheduling information is configured to receive, from the second UE in a physical sidelink control channel (PSCCH), a resource allocation for the sidelink data; and the transceiver is further configured to transmit, to the second UE in at least one of the PSCCH or a physical sidelink shared channel (PSSCH), a transmission parameter including at least one of a modulation coding scheme (MCS) or a demodulation references signal (DMRS) pattern for the sidelink data. The transceiver configured to receive the at least one of the sidelink channel information or the sidelink scheduling information is configured to receive, from the second UE, the sidelink channel information including at least one of a channel quality indicator or channel sensing information. The transceiver is further configured to transmit, to the second UE, at least one of a resource allocation or a transmission parameter for the sidelink data based on the received sidelink channel information. The transceiver is further configured to transmit, to the second UE, a sidelink data pending indication; and the transceiver configured to receive the at least one of the sidelink channel information or the sidelink scheduling information is configured to receive, from the second UE, the sidelink scheduling information in response to the sidelink data pending indication. The transceiver configured to transmit the sidelink data pending indication is configured to transmit, to the second UE, another sidelink data multiplexed with the sidelink data pending indication. The transceiver is further configured to receive, from the second UE, another sidelink data; and the transceiver configured to transmit the sidelink data pending indication is configured to transmit, to the second UE, an acknowledgement/negative-acknowledgement (ACK/NACK) feedback for the another sidelink data multiplexed with the sidelink data pending indication.

Further aspects of the present disclosure include a base station (BS). The base station includes a processor configured to determine a sidelink grant for a first user equipment (UE) to transmit sidelink data to a second UE; and a transceiver configured to transmit, to the second UE, the sidelink grant for initiating a transmission of the sidelink data.

The BS may also include one or more of the following features. For instance, the BS includes where the transceiver is further configured to receive, from the second UE, sidelink channel information associated with the first UE and the second UE; and the processor configured to determine the sidelink grant is configured to determine the sidelink grant based on the sidelink channel information. The transceiver is further configured to receive, from the first UE, a sidelink data pending indication; and the processor configured to determine the sidelink grant is configured to determine the sidelink grant based on the sidelink data pending indication. The transceiver is further configured to receive, from the second UE, a sidelink data pending indication, the processor configured to determine the sidelink grant is configured to determine the sidelink grant based on the sidelink data pending indication. The transceiver is further configured to receive, from the second UE, an acknowledgement/negative-acknowledgement (ACK/NACK) for the sidelink data. The processor configured to determine the sidelink grant is configured to determine the sidelink grant based on a transmission delay between the BS and the second UE and a transmission delay between the second UE and the first UE.

Further aspects of the present disclosure include a first user equipment (UE). The first user equipment includes a processor configured to determine, a sidelink channel occupancy time (COT) in a shared radio frequency band in response to failure to detect a sidelink communication; and a transceiver configured to transmit, to a second UE, a sidelink COT indicator including information for sharing the sidelink COT.

The first UE may also include one or more of the following features. For instance, the first UE includes where the transceiver is further configured to receive, from the second UE, a sidelink data pending indication; and the processor configured to determine the sidelink COT is configured to determine the sidelink COT based on the sidelink data pending indication. The processor configured to determine the sidelink COT is configured to determine the sidelink COT based on a timer. The timer is associated with a time when the first UE receives a communication from the second UE or a base station (BS). The processor is further configured to determine a time period for the timer based on whether the communication includes data or control information. The processor is further configured to determine a time period for the timer based on whether the first UE expect data from the second UE or the BS.

Further aspects of the present disclosure include a non-transitory computer-readable medium having program code recorded thereon. The non-transitory computer-readable medium includes code for causing a first user equipment (UE) to transmit at least one of sidelink channel information or a sidelink scheduling information. The non-transitory computer-readable medium also includes code for causing the first UE to receive, from a second UE, sidelink data based on at least one of the transmitted sidelink channel information or the transmitted sidelink scheduling information.

The non-transitory computer-readable medium may also include one or more of the following features. For instance, the non-transitory computer-readable medium includes where the code for causing the first UE to transmit the at least one of the sidelink channel information or the sidelink scheduling information is configured to transmit, to the second UE, the sidelink scheduling information including a resource allocation for transmit the sidelink data. The code for causing the first UE to transmit the sidelink scheduling information is configured to transmit, to the second UE, a transmission parameter including at least one of a modulation coding scheme (MCS) or a demodulation reference signal (DMRS) pattern for the sidelink data. The code for causing the first UE to transmit the sidelink scheduling information is configured to transmit, to the second UE in a physical sidelink control channel (PSCCH), the resource allocation; and transmit, to the second UE in at least one of the PSCCH or a physical sidelink shared channel (PSSCH), the transmission parameter. The code for causing the first UE to transmit the sidelink scheduling information is configured to transmit, to the second UE in a physical sidelink control channel (PSCCH), a resource allocation for the sidelink data; and the non-transitory computer-readable medium further includes code for causing the first UE to receive, from the second UE in at least one of the PSCCH or a physical sidelink shared channel (PSSCH), a transmission parameter including at least one of a modulation coding scheme (MCS) or a demodulation reference signal (DMRS) pattern for the sidelink data. The non-transitory computer-readable medium may include code for causing the first UE to determine the sidelink scheduling information based on channel sensing. The non-transitory computer-readable medium may include code for causing the first UE to perform the channel sensing based on sidelink control information (SCI) decoding. The code for causing the first UE to transmit the at least one of the sidelink channel information or the sidelink scheduling information is configured to transmit, the sidelink channel information including at least one of a channel quality indicator or channel sensing information. The non-transitory computer-readable medium may include receive at least one of a resource allocation or a transmission parameter for the sidelink data based on the sidelink channel information. The code for causing the first UE to transmit the at least one of the sidelink channel information or the sidelink scheduling information is configured to transmit, to the second UE, the sidelink scheduling information based on the received sidelink grant. The non-transitory computer-readable medium may include code for causing the first UE to transmit, to the BS, an acknowledgement/negative-acknowledgement (ACK/NACK) for the sidelink data received from the second UE. The non-transitory computer-readable medium may include code for causing the first UE to transmit, to the second UE, a retransmission schedule for the sidelink data. The code for causing the first UE to transmit the at least one of the sidelink channel information or the sidelink scheduling information is configured to transmit, to the second UE, the sidelink scheduling information in response to a sidelink data pending indication. The non-transitory computer-readable medium may include receive, from the second UE, another sidelink data multiplexed with the sidelink data pending indication. The non-transitory computer-readable medium may include code for causing the first UE to transmit, to the second UE, another sidelink data; and code for causing the first UE to receive, from the second UE, an acknowledgement/negative-acknowledgement (ACK/NACK) feedback for the another sidelink data multiplexed with the sidelink data pending indication. The code for causing the first UE to transmit the at least one of the sidelink channel information or the sidelink scheduling information is configured to transmit, to the second UE, the sidelink scheduling information indicating a first resource for transmit the sidelink data; and the non-transitory computer-readable medium further includes code for causing the first UE to transmit, to a third UE different from the second UE, an indication of a second resource for transmit another sidelink data, where the second resource is multiplexed with the first resource in at least one of a time domain, a frequency domain, or a spatial domain.

Further aspects of the present disclosure include a non-transitory computer-readable medium having program code recorded thereon. The non-transitory computer-readable medium includes code for causing a first user equipment (UE) to receive, from a second UE, at least one of sidelink channel information or a sidelink scheduling information. The non-transitory computer-readable medium also includes code for causing the first UE to transmit, to the second UE, sidelink data based on at least one of the received sidelink channel information or the received sidelink scheduling information.

The non-transitory computer-readable medium may also include one or more of the following features. For instance, the non-transitory computer-readable medium includes where the code for causing the first UE to receive the at least one of the sidelink channel information or the sidelink scheduling information is configured to receive, from the second UE, the sidelink scheduling information including a resource allocation for transmit the sidelink data. The code for causing the first UE to receive the sidelink scheduling information is configured to receive, from the second UE, a transmission parameter including at least one of a modulation coding scheme (MCS) or a demodulation references signal (DMRS) pattern for the sidelink data. The code for causing the first UE to receive the sidelink scheduling information is configured to receive, from the second UE in a physical sidelink control channel (PSCCH), the resource allocation; and receive, from the second UE in at least one of the PSCCH or a physical sidelink shared channel (PSSCH), the transmission parameter. The code for causing the first UE to receive the sidelink scheduling information is configured to receive, from the second UE in a physical sidelink control channel (PSCCH), a resource allocation for the sidelink data; and the non-transitory computer-readable medium further includes code for causing the first UE to transmit, to the second UE in at least one of the PSCCH or a physical sidelink shared channel (PSSCH), a transmission parameter including at least one of a modulation coding scheme (MCS) or a demodulation references signal (DMRS) pattern for the sidelink data. The code for causing the first UE to receive the at least one of the sidelink channel information or the sidelink scheduling information is configured to receive, from the second UE, the sidelink channel information including at least one of a channel quality indicator or channel sensing information. The non-transitory computer-readable medium may include code for causing the first UE to transmit, to the second UE, at least one of a resource allocation or a transmission parameter for the sidelink data based on the received sidelink channel information. The non-transitory computer-readable medium may include code for causing the first UE to transmit, to the second UE, a sidelink data pending indication; and the code for causing the first UE to receive the at least one of the sidelink channel information or the sidelink scheduling information is configured to receive, from the second UE, the sidelink scheduling information in response to the sidelink data pending indication. The code for causing the first UE to transmit the sidelink data pending indication is configured to transmit, to the second UE, another sidelink data multiplexed with the sidelink data pending indication. The non-transitory computer-readable medium may include code for causing the first UE to receive, from the second UE, another sidelink data; and the code for causing the first UE to transmit the sidelink data pending indication is configured to transmit, to the second UE, an acknowledgement/negative-acknowledgement (ACK/NACK) feedback for the another sidelink data multiplexed with the sidelink data pending indication.

Further aspects of the present disclosure include a non-transitory computer-readable medium having program code recorded thereon. The non-transitory computer-readable medium includes code for causing a base station (BS) to determine a sidelink grant for a first user equipment (UE) to transmit sidelink data to a second UE; and code for causing the BS to transmit, to the second UE, the sidelink grant for initiating a transmission of the sidelink data.

The non-transitory computer-readable medium may also include one or more of the following features. For instance, the non-transitory computer-readable medium may include code for causing the BS to receive, from the second UE, sidelink channel information associated with the non-transitory computer-readable medium and the second UE; and the code for causing the BS to determine the sidelink grant is configured to determine the sidelink grant based on the sidelink channel information. The non-transitory computer-readable medium may include code for causing the BS to receive, from the non-transitory computer-readable medium, a sidelink data pending indication; and the code for causing the BS to determine the sidelink grant is configured to determine the sidelink grant based on the sidelink data pending indication. The non-transitory computer-readable medium may include code for causing the BS to receive, from the second UE, a sidelink data pending indication, the code for causing the BS to determine the sidelink grant is configured to determine the sidelink grant based on the sidelink data pending indication. The non-transitory computer-readable medium may include code for causing the BS to receive, from the second UE, an acknowledgement/negative-acknowledgement (ACK/NACK) for the sidelink data. The code for causing the BS to determine the sidelink grant is configured to determine the sidelink grant based on a transmission delay between the BS and the second UE and a transmission delay between the second UE and the non-transitory computer-readable medium.

Further aspects of the present disclosure include a non-transitory computer-readable medium having program code recorded thereon. The non-transitory computer-readable medium includes code for causing a first user equipment (UE) to determine, a sidelink channel occupancy time (COT) in a shared radio frequency band in response to failure to detect a sidelink communication; and code for causing the first UE to transmit, to a second UE, a sidelink COT indicator including information for sharing the sidelink COT.

The non-transitory computer-readable medium may also include one or more of the following features. For instance, the non-transitory computer-readable medium may include code for causing the first UE to receive, from the second UE, a sidelink data pending indication; and the code for causing the first UE to determine the sidelink COT is configured to determine the sidelink COT based on the sidelink data pending indication. The code for causing the first UE to determine the sidelink COT is configured to determine the sidelink COT based on a timer. The timer is associated with a time when the first UE receives a communication from the second UE or a base station (BS). The non-transitory computer-readable medium may include code for causing the first UE to determine a time period for the timer based on whether the communication includes data or control information. The non-transitory computer-readable medium may include code for causing the first UE to determine a time period for the timer based on whether the non-transitory computer-readable medium expect data from the second UE or the BS.

Further aspects of the present disclosure include a first user equipment (UE). The first user equipment includes means for transmitting at least one of sidelink channel information or a sidelink scheduling information. The first user equipment also includes means for receiving, from a second UE, sidelink data based on at least one of the transmitted sidelink channel information or the transmitted sidelink scheduling information.

The first UE may also include one or more of the following features. For instance, the first UE includes where the means for transmitting the at least one of the sidelink channel information or the sidelink scheduling information is configured to transmit, to the second UE, the sidelink scheduling information including a resource allocation for transmit the sidelink data. The means for transmitting the sidelink scheduling information is configured to transmit, to the second UE, a transmission parameter including at least one of a modulation coding scheme (MCS) or a demodulation reference signal (DMRS) pattern for the sidelink data. The means for transmitting the sidelink scheduling information is configured to transmit, to the second UE in a physical sidelink control channel (PSCCH), the resource allocation; and transmit, to the second UE in at least one of the PSCCH or a physical sidelink shared channel (PSSCH), the transmission parameter. The means for transmitting the sidelink scheduling information is configured to transmit, to the second UE in a physical sidelink control channel (PSCCH), a resource allocation for the sidelink data; and the first UE further includes means for receiving, from the second UE in at least one of the PSCCH or a physical sidelink shared channel (PSSCH), a transmission parameter including at least one of a modulation coding scheme (MCS) or a demodulation reference signal (DMRS) pattern for the sidelink data. The first UE may include means for determining the sidelink scheduling information based on channel sensing. The first UE may include means for perform the channel sensing based on sidelink control information (SCI) decoding. The means for transmitting the at least one of the sidelink channel information or the sidelink scheduling information is configured to transmit, the sidelink channel information including at least one of a channel quality indicator or channel sensing information. The first UE may include receive at least one of a resource allocation or a transmission parameter for the sidelink data based on the sidelink channel information. The means for transmitting the at least one of the sidelink channel information or the sidelink scheduling information is configured to transmit, to the second UE, the sidelink scheduling information based on the received sidelink grant. The first UE may include means for transmitting, to the BS, an acknowledgement/negative-acknowledgement (ACK/NACK) for the sidelink data received from the second UE. The first UE may include means for transmitting, to the second UE, a retransmission schedule for the sidelink data. The means for transmitting the at least one of the sidelink channel information or the sidelink scheduling information is configured to transmit, to the second UE, the sidelink scheduling information in response to a sidelink data pending indication. The first UE may include receive, from the second UE, another sidelink data multiplexed with the sidelink data pending indication. The first UE may include means for transmitting, to the second UE, another sidelink data; and means for receiving, from the second UE, an acknowledgement/negative-acknowledgement (ACK/NACK) feedback for the another sidelink data multiplexed with the sidelink data pending indication. The means for transmitting the at least one of the sidelink channel information or the sidelink scheduling information is configured to transmit, to the second UE, the sidelink scheduling information indicating a first resource for transmit the sidelink data; and the first UE further includes means for transmitting, to a third UE different from the second UE, an indication of a second resource for transmit another sidelink data, where the second resource is multiplexed with the first resource in at least one of a time domain, a frequency domain, or a spatial domain.

Further aspects of the present disclosure include a first user equipment (UE). The first user equipment includes means for receiving, from a second UE, at least one of sidelink channel information or a sidelink scheduling information. The first user equipment also includes means for transmitting, to the second UE, sidelink data based on at least one of the received sidelink channel information or the received sidelink scheduling information.

The first UE may also include one or more of the following features. For instance, the first UE includes where the means for receiving the at least one of the sidelink channel information or the sidelink scheduling information is configured to receive, from the second UE, the sidelink scheduling information including a resource allocation for transmit the sidelink data. The means for receiving the sidelink scheduling information is configured to receive, from the second UE, a transmission parameter including at least one of a modulation coding scheme (MCS) or a demodulation references signal (DMRS) pattern for the sidelink data. The means for receiving the sidelink scheduling information is configured to receive, from the second UE in a physical sidelink control channel (PSCCH), the resource allocation; and receive, from the second UE in at least one of the PSCCH or a physical sidelink shared channel (PSSCH), the transmission parameter. The means for receiving the sidelink scheduling information is configured to receive, from the second UE in a physical sidelink control channel (PSCCH), a resource allocation for the sidelink data; and the first UE further includes means for transmitting, to the second UE in at least one of the PSCCH or a physical sidelink shared channel (PSSCH), a transmission parameter including at least one of a modulation coding scheme (MCS) or a demodulation references signal (DMRS) pattern for the sidelink data. The means for receiving the at least one of the sidelink channel information or the sidelink scheduling information is configured to receive, from the second UE, the sidelink channel information including at least one of a channel quality indicator or channel sensing information. The first UE may include means for transmitting, to the second UE, at least one of a resource allocation or a transmission parameter for the sidelink data based on the received sidelink channel information. The means for receiving the at least one of the sidelink channel information or the sidelink scheduling information is configured to receive, from the second UE, the sidelink scheduling information in response to the sidelink data pending indication. The means for transmitting the sidelink data pending indication is configured to transmit, to the second UE, another sidelink data multiplexed with the sidelink data pending indication. The means for transmitting the sidelink data pending indication is configured to transmit, to the second UE, an acknowledgement/negative-acknowledgement (ACK/NACK) feedback for the another sidelink data multiplexed with the sidelink data pending indication.

Further aspects of the present disclosure include a base station (BS). The base station includes means for determining a sidelink grant for a first user equipment (UE) to transmit sidelink data to a second UE; and means for transmitting, to the second UE, the sidelink grant for initiating a transmission of the sidelink data.

The BS may also include one or more of the following features. For instance, the BS may include means for receiving, from the second UE, sidelink channel information associated with the first UE and the second UE, where the means for determining the sidelink grant is configured to determine the sidelink grant based on the sidelink channel information. The means for determining the sidelink grant is configured to determine the sidelink grant based on the sidelink data pending indication. The means for determining the sidelink grant is configured to determine the sidelink grant based on the sidelink data pending indication. The BS may include means for receiving, from the second UE, an acknowledgement/negative-acknowledgement (ACK/NACK) for the sidelink data. The means for determining the sidelink grant is configured to determine the sidelink grant based on a transmission delay between the BS and the second UE and a transmission delay between the second UE and the first UE.

Further aspects of the present disclosure include a first user equipment (UE). The first user equipment includes means for determining, a sidelink channel occupancy time (COT) in a shared radio frequency band in response to failure to detect a sidelink communication; and means for transmitting, to a second UE, a sidelink COT indicator including information for sharing the sidelink COT.

The first UE may also include one or more of the following features. For instance, the first UE may include means for receiving, from the second UE, a sidelink data pending indication, where the means for determining the sidelink COT is configured to determine the sidelink COT based on the sidelink data pending indication. The means for determining the sidelink COT is configured to determine the sidelink COT based on a timer. The timer is associated with a time when the first UE receives a communication from the second UE or a base station (BS). The first UE may include means for determining a time period for the timer based on whether the communication includes data or control information. The first UE may include means for determining a time period for the timer based on whether the first UE expect data from the second UE or the BS.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular aspects illustrated and described herein, as they are merely by way of some examples thereof, but rather, should be fully commensurate with that of the claims appended hereafter and their functional equivalents.

What is claimed is:

1. A method of wireless communication, comprising:
transmitting, by a first user equipment (UE), at least one of sidelink channel information or a sidelink scheduling information; and
receiving, by the first UE from a second UE, sidelink data based on at least one of the transmitted sidelink channel information or the transmitted sidelink scheduling information.

2. The method of claim 1, wherein the transmitting comprises:
transmitting, by the first UE to the second UE, the sidelink scheduling information including a resource allocation for transmitting the sidelink data.

3. The method of claim 2, wherein the transmitting the sidelink scheduling information comprises:
transmitting, by the first UE to the second UE, a transmission parameter including at least one of a modulation coding scheme (MCS) or a demodulation reference signal (DMRS) pattern for the sidelink data.

4. The method of claim 3, wherein the transmitting the sidelink scheduling information comprises:
transmitting, by the first UE to the second UE in a physical sidelink control channel (PSCCH), the resource allocation; and
transmitting, by the first UE to the second UE in at least one of the PSCCH or a physical sidelink shared channel (PSSCH), the transmission parameter.

5. The method of claim 1, wherein:
the transmitting comprises:
transmitting, by the first UE to the second UE in a physical sidelink control channel (PSCCH), a resource allocation for the sidelink data; and
the method further comprises:
receiving, by the first UE from the second UE in at least one of the PSCCH or a physical sidelink shared channel (PSSCH), a transmission parameter including at least one of a modulation coding scheme (MCS) or a demodulation reference signal (DMRS) pattern for the sidelink data.

6. The method of claim 1, further comprising:
performing, by the first UE, channel sensing based on sidelink control information (SCI) decoding; and
determining, by the first UE, the sidelink scheduling information based on channel sensing,
wherein the transmitting comprises:
transmitting the sidelink scheduling information to initiate a transmission of the sidelink data to the first UE.

7. The method of claim 1, wherein:
the transmitting comprises:
transmitting, by the first UE, the sidelink channel information including at least one of a channel quality indicator or channel sensing information,
the method further comprises:
receiving, by the first UE, at least one of a resource allocation or a transmission parameter for the sidelink data based on the sidelink channel information.

8. The method of claim 1, further comprising:
receiving, by the first UE from a base station (BS), a sidelink grant,
wherein the transmitting further comprises:
transmitting, by the first UE to the second UE, the sidelink scheduling information based on the received sidelink grant.

9. The method of claim 1, further comprising:
transmitting, by the first UE to the second UE, a retransmission schedule for the sidelink data.

10. The method of claim 1, wherein the transmitting comprises:
transmitting, by the first UE to the second UE, the sidelink scheduling information in response to a sidelink data pending indication.

11. The method of claim 10, further comprising:
transmitting, by the first UE to the second UE, another sidelink data; and
receiving, by the first UE from the second UE, an acknowledgement/negative-acknowledgement (ACK/NACK) feedback for the another sidelink data multiplexed with the sidelink data pending indication.

12. The method of claim 1, wherein:
the transmitting comprises:
transmitting, by the first UE to the second UE, the sidelink scheduling information indicating a first resource for transmitting the sidelink data; and
the method further comprises:
transmitting, by the first UE to a third UE different from the second UE, an indication of a second resource for transmitting another sidelink data, wherein the second resource is multiplexed with the first resource in at least one of a time domain, a frequency domain, or a spatial domain.

13. A method of wireless communication, comprising:
receiving, by a first user equipment (UE) from a second UE, at least one of sidelink channel information or a sidelink scheduling information; and
transmitting, by the first UE to the second UE, sidelink data based on at least one of the received sidelink channel information or the received sidelink scheduling information.

14. The method of claim 13, wherein the receiving comprises:
receiving, by the first UE from the second UE, the sidelink scheduling information including a resource allocation for transmitting the sidelink data.

15. The method of claim 14, wherein the receiving the sidelink scheduling information comprises:
receiving, by the first UE from the second UE, a transmission parameter including at least one of a modulation coding scheme (MCS) or a demodulation references signal (DMRS) pattern for the sidelink data.

16. The method of claim 15, wherein the receiving the sidelink scheduling information comprises:
receiving, by the first UE from the second UE in a physical sidelink control channel (PSCCH), the resource allocation; and
receiving, by the first UE from the second UE in at least one of the PSCCH or a physical sidelink shared channel (PSSCH), the transmission parameter.

17. The method of claim 13, wherein:
the receiving the sidelink scheduling information further comprises:
receiving, by the first UE from the second UE in a physical sidelink control channel (PSCCH), a resource allocation for the sidelink data; and
the method further comprises:
transmitting, by the first UE to the second UE in at least one of the PSCCH or a physical sidelink shared channel (PSSCH), a transmission parameter including at least one of a modulation coding scheme (MCS) or a demodulation references signal (DMRS) pattern for the sidelink data.

18. The method of claim 13, wherein:
the receiving comprises:
receiving, by the first UE from the second UE, the sidelink channel information including at least one of a channel quality indicator or channel sensing information; and
the method further comprises:
transmitting, by the first UE to the second UE, at least one of a resource allocation or a transmission parameter for the sidelink data based on the received sidelink channel information.

19. The method of claim 13, further comprising:
receiving, by the first UE from the second UE, a retransmission schedule for the sidelink data.

20. The method of claim 13, further comprising:
transmitting, by the first UE to the second UE, a sidelink data pending indication,
wherein the receiving comprises:
receiving, by the first UE from the second UE, the sidelink scheduling information in response to the sidelink data pending indication.

21. The method of claim 20, further comprising:
receiving, by the first UE from the second UE, another sidelink data,
wherein the transmitting the sidelink data pending indication comprises:
transmitting, by the first UE to the second UE, an acknowledgement/negative-acknowledgement (ACK/NACK) feedback for the another sidelink data multiplexed with the sidelink data pending indication.

22. A first user equipment (UE) comprising:
a transceiver configured to:
transmit at least one of sidelink channel information or sidelink scheduling information; and
receive, from a second UE, sidelink data based on at least one of the transmitted sidelink channel information or the transmitted sidelink scheduling information.

23. The first UE of claim 22, wherein the transceiver configured to transmit the at least one of the sidelink channel information or the sidelink scheduling information is configured to:
transmit, to the second UE, the sidelink scheduling information including a resource allocation for transmit the sidelink data.

24. The first UE of claim 22, wherein:
the transceiver configured to transmit the sidelink scheduling information is configured to:
transmit, to the second UE in a physical sidelink control channel (PSCCH), a resource allocation for the sidelink data; and
the transceiver is further configured to:
receive, from the second UE in at least one of the PSCCH or a physical sidelink shared channel (PSSCH), a transmission parameter including at least one of a modulation coding scheme (MCS) or a demodulation reference signal (DMRS) pattern for the sidelink data.

25. The first UE of claim 22, further comprising a processor configured to:
perform channel sensing based on sidelink control information (SCI) decoding; and
determine the sidelink scheduling information based on the channel sensing,
wherein the transceiver configured to transmit the at least one of the sidelink channel information or the sidelink scheduling information is configured to:
transmit the sidelink scheduling information to initiate a transmission of the sidelink data to the first UE.

26. The first UE of claim 22, wherein:
the transceiver configured to transmit the at least one of the sidelink channel information or the sidelink scheduling information is configured to:
transmit, the sidelink channel information including at least one of a channel quality indicator or channel sensing information; and
the transceiver is further configured to:
receive at least one of a resource allocation or a transmission parameter for the sidelink data based on the sidelink channel information.

27. A first user equipment (UE) comprising:
a transceiver configured to:
receive, from a second UE, at least one of sidelink channel information or sidelink scheduling information; and
transmit, to the second UE, sidelink data based on at least one of the received sidelink channel information or the received sidelink scheduling information.

28. The first UE of claim 27, wherein the transceiver configured to receive the at least one of the sidelink channel information or the sidelink scheduling information is configured to:
receive, from the second UE, the sidelink scheduling information including a resource allocation for transmit the sidelink data.

29. The first UE of claim 27, wherein:
the transceiver configured to receive the sidelink scheduling information is configured to:
receive, from the second UE in a physical sidelink control channel (PSCCH), a resource allocation for the sidelink data; and
the transceiver is further configured to:
transmit, to the second UE in at least one of the PSCCH or a physical sidelink shared channel (PSSCH), a transmission parameter including at least one of a modulation coding scheme (MCS) or a demodulation references signal (DMRS) pattern for the sidelink data.

30. The first UE of claim 27, wherein:
the transceiver configured to receive the at least one of the sidelink channel information or the sidelink scheduling information is configured to:
receive, from the second UE, the sidelink channel information including at least one of a channel quality indicator or channel sensing information; and
the transceiver is further configured to:
transmit, to the second UE, at least one of a resource allocation or a transmission parameter for the sidelink data based on the received sidelink channel information.
